(19) United States
(12) Patent Application Publication
(10) Pub. No.: US 2022/0194774 A1
(43) Pub. Date: Jun. 23, 2022

(54) BEVERAGE DISPENSER

(71) Applicant: Asept International AB, Lund (SE)

(72) Inventors: Nils Anders PERSSON BERG, Teckomatorp (SE); Ulf Håkan LARSSON, Malmö (SE)

(21) Appl. No.: 17/602,559

(22) PCT Filed: Apr. 7, 2020
(86) PCT No.: PCT/EP2020/059915

§ 371 Date: Oct. 8, 2021

(30) Foreign Application Priority Data
Apr. 12, 2019 (SE) 1950461-2

(51) Int. Cl. B67D 3/04

(52) U.S. Cl. CPC B67D 3/042; B67D 3/047

(57) ABSTRACT

The present invention concerns a valve (1) for dispensing liquid substances from a closed and airtight container (3), the valve (1) comprising a valve housing (10) with a first end (10A) configured to be detachably attached to and in fluid communication with the container and a second end (10B) at which the liquid substance is to be dispensed in a dispensing direction by means of gravity. The dispensing valve (1) is useful in dispensing and has a more reliable and/or reproducible and simpler emptying of a closed and airtight/airproof container by means of an improved changing of air with liquid substance in the container when it is being emptied/dispensed.

### TECHNICAL FIELD

The present invention relates to a dispensing valve, useful in a dispensing device, for dispensing liquid substances, such as liquid foods or beverages, such as juice, e.g. apple juice, orange juice, ice tea or the like besides a preferred drinkable liquid being water, and/or liquid soap or detergents or personal care products in liquid form from a closed container, i.e. a container in which its content is not in communication with the atmosphere or in contact with surrounding air. The valve comprises a valve housing with a first end configured to be detachably attached to and having an inlet adapted to be in fluid communication with an opening of the container and a second end with an outlet at which the liquid substance is to be dispensed in a dispensing direction by means of gravity. In other words, the present invention relates to a fluid dispensing valve, such as a liquid dispensing valve and particularly to a water dispensing valve, the fluid/liquid/water being hermetically stored in the closed container before dispensing it to a user.

### BACKGROUND ART

Within the food industry there are many examples of devices for dispensing of foods, such as sauces, ketchup, mustard or the like, and/or water, such as water coolers having a large water bottle put upside down and connected to a valve device at its bottle neck and bottle opening.

Examples of devices for enabling discharge of product out of containers can be found e.g. in US 2005/0067441 A1.

Disadvantages of known dispensing/discharging devices when they are applied to containers, among others, are that they are difficult to handle, with risk of spillage of discharged product and increased risk of leakage of product, and require cumbersome ways of opening and closing their valves, which valves often are complex in structure as being made up of many cooperating parts, and often not able to accomplish full draining of the content from those prior art containers or bottles, also resulting in food or beverage or water waste.

### SUMMARY OF THE INVENTION

One object of the invention is to provide a valve for dispensing liquid substance, such as liquid foods or beverages, e.g. juice or ice tea or water, and/or liquid soap or detergents or personal care products in liquid form from a closed container, which solves or at least reduces one or more of above problems.

Another object of the invention is to provide a detachable valve for dispensing liquid substance, such as liquid foods or beverages, e.g. juice or ice tea or water, and/or liquid soap or detergents or personal care products in liquid form from a closed container, which valve selectively releases/dispenses and stops flow of liquid substance out of the container and optimizes the yield of liquid substance during dispense.

One other object of the present invention is, inter alia, to provide a dispensing valve and function, useful in a dispensing device, making it possible to quickly feed out relatively large amounts of any of the above liquid substances from the contents of the storage container, and/or to quickly open and close the valve means and/or to quietly and/or smoothly dispense the liquid substance.

One or more of the above objects are achieved by means of a valve for dispensing liquid substance, such as a beverage in liquid form and/or water in liquid form, as claimed in the associated independent claim, preferred variants thereof being defined in associated dependent claims.

According to an aspect there is provided a valve for dispensing liquid substance, such as beverages and/or water in liquid form from a closed and airtight/airproof container, the valve comprising a valve housing with a first end configured to be detachably attached to and in fluid communication with the container and a second end at which the liquid substance and/or water is to be dispensed in a dispensing direction by means of gravity, wherein at least one inlet configured to receive the liquid substance and/or water (from the container) is arranged at the first valve housing end and at least one outlet configured to let out the liquid substance and/or water is arranged at/closer to the second valve housing end, which in- and outlets are configured to be in fluid communication via at least one inner passageway through the valve housing, and a at least partly flexible member detachably fitted into the valve housing, the flexible member being malleable and/or deformable and/or pliable infinitely variable, i.e. in an infinitely variable way, between a first shape sealingly closing off the inner passageway to hinder dispense of the liquid substance and/or water from the container and a second shape opening up the inner passageway to enable dispensing the liquid substance and/or water from at least one inlet (of the valve) via the inner passageway and out of at least one outlet (of the valve), wherein the valve comprises two inlets for the liquid substance and/or the water (in liquid form), a first liquid substance/water inlet and a second liquid substance/water inlet at its first valve housing end, and that the first liquid substance/water inlet for receiving the liquid substance and/or the water is arranged closer to the at least one outlet than the second liquid substance/water inlet for receiving the the liquid substance and/or the water, in the dispensing direction. This valve is adapted to be used in a dispensing system as defined below. One advantage of above aspect and any of the below aspects is that a non-interrupted flow of content out of the container during the whole dispensing procedure is achieved, i.e. from initiation to finishing, to guarantee a simple and quick dispensing of desired amount of container content and emptying of the container if desired to fully empty it. Another advantage of above aspect and any of the below aspects is that a steady and/or continuous flow of content with small fluctuations out of the container during the whole dispensing procedure is achieved, i.e. from initiation to finishing, to guarantee an easy to control and clearly visible and distinct dispensing of desired amount of container content and emptying of the container if desired to fully empty it.

Further objects and features of the present invention will appear from the following definitions of aspects/examples/embodiments thereof.

According to an aspect, in the valve according to any of the above/former and/or below/latter aspects, the at least partly flexible member is malleable between its first shape sealingly closing off both the inner passageway and the at least one valve housing outlet for hindering dispense of the liquid substance and/or the water from the container and its second shape opening up both the inner passage-way and the at least one valve housing outlet to enable dispensing the liquid substance and/or the water from at least one liquid substance and/or water inlet via the inner passageway and out of the at least one valve housing outlet.

According to another aspect, in the valve according to any of the above and/or below aspects, the first liquid substance/water inlet is configured as a first orifice of an inner hollow channel or protrusion extending a length inside the valve housing from the first valve housing end towards the second valve housing end and ending in a second outlet or orifice at/above/adjacent/close to the flexible member (or even in contact therewith) to enable the liquid substance and/or the water to flow from the first liquid substance/water inlet through the inner hollow protrusion and out of the second outlet or orifice and the at least one outlet via the inner passageway and the flexible member when the flexible member is in its second shape.

In one aspect, in the valve according to any of the above and/or below aspects, the valve housing has a centre axis extending in parallel with the length of the valve housing and the first liquid substance/water inlet is aligned with the valve housing centre axis and the second liquid substance/water inlet is radially offset/displaced relative the valve housing centre axis. In another aspect, the second liquid substance/water inlet is aligned with the valve housing centre axis and the first liquid substance/water inlet is radially offset/displaced relative the valve housing centre axis. In yet one aspect, the first or second liquid substance/water inlet is aligned/in parallel with the valve housing centre axis. In one other aspect, the centre axis of the first or second liquid substance/water inlet coincides with the valve housing centre axis. In still another aspect, the second liquid substance/water inlet is arranged at/closer to the valve housing periphery than the first liquid substance/water inlet.

In yet another aspect, in the valve according to any of the above and/or below aspects, the second liquid substance/water inlet is configured as a first orifice of an external hollow channel or protrusion on the first valve housing end, which external hollow protrusion is extending outwards away from the first valve housing end similar to a chimney ending in/at/as the second liquid substance/water inlet as a free orifice at a distance from the first valve housing end to enable the liquid substance and/or the water to flow from the second liquid substance/water inlet through the external hollow protrusion and out of its second outlet or orifice into the valve housing and out of at least one outlet via the inner passageway and the flexible member when the flexible member is in its second shape.

According to a further aspect, in the valve according to any preceding and/or subsequent aspect, only the second liquid substance/water inlet is configured to enable air to flow into the at least one outlet and into the valve housing and further into the second outlet or orifice of the external hollow channel or protrusion via the inner passageway and the flexible member in a direction substantially opposite or opposite the liquid substance/water dispensing direction and dispensing direction and out through the external hollow channel or protrusion and second liquid substance inlet acting as a free orifice (and into the container) while liquid substance and/or water flows in (into the valve housing) when the flexible member is in its second shape. In another aspect, only the first liquid substance and/or water inlet is configured to enable air to flow into the at least one outlet and into the valve housing and further into its inner lower orifice and through its inner channel and out of its upper orifice via the inner passageway and the flexible member into the container in a direction substantially opposite or opposite the liquid substance/water dispensing direction and dispensing direction while liquid substance and/or water flows into the valve housing when the flexible member is in its second shape. In yet one aspect, the first and the second liquid substance/water inlet are configured to enable air to flow into the at least one outlet and into the valve housing and further into their inner lower outlets or orifices and through their inner channels and out of their upper substance/water inlets or orifices via the inner passageway and the flexible member into the container in a direction substantially opposite or opposite the liquid substance/water dispensing direction and dispensing direction while liquid substance and/or water flows into the valve housing in principle simultaneously and/or in principle in parallel when the flexible member is in its second shape. This eliminates or at least greatly reduces any “negative” or lower pressure within the container compared to the surroundings/atmosphere improving/simplifying the emptying of the container content.

According to a still further aspect, in the valve according to any of the above and/or below aspects, the first liquid substance/water inlet is arranged flush with the first valve housing end or below the upper/exposed surface of the first valve housing end, i.e. immersed, as an opening in the first valve housing end. This improves emptying effectiveness as the upper opening of the first liquid substance/water inlet then is more distinctly placed at a distance from the upper opening at the free end of the second liquid substance/water inlet securing a pressure difference there between.

According to yet an aspect, in the valve according to any preceding and/or subsequent aspect, the second liquid substance/water inlet is arranged at a free end of an external hollow channel or a protrusion or a tubular protrusion extending away and outwards from the first valve housing end in a direction substantially perpendicular or perpendicular to the extension plane of the first valve housing end, which tubular protrusion ends at a distance from the first valve housing end. This improves emptying of the container as a distance or more distinct distance between the upper opening at the free end of the second liquid substance/water inlet and the first valve housing end with the first liquid substance/water inlet is achieved securing a difference in content level or height or length or volume incurring different pressures there between.

According to another aspect, in the valve according to any preceding and/or subsequent aspect, the at least one valve housing outlet is an opening through the valve housing, which opening extends at an angle/inclined relative the length/centre axis of the valve housing or, in another aspect, which opening extends substantially perpendicularly or perpendicularly to the length/centre axis of the valve housing. This angle is between about 10°/20° to about 90° as measured from the centre axis of the valve housing.

According to one more aspect, in the valve according to any preceding and/or subsequent aspect, the valve housing comprises at least one side wall extending substantially perpendicularly or perpendicularly to its first and second ends, which at least one side wall is fenestrated via at least one through opening forming the at least one outlet, which outlet has an extension plane being substantially in parallel with or in parallel with the at least one side wall/centre axis of the valve housing.

According to an additional aspect, in the valve according to any of the above and/or below aspects, the flexible member is formed with at least a partly tubular shape and comprises at least one wall section being part of the at least partly tubular shape, which at least one wall section is adapted to sealingly abut against the at least one valve housing outlet from inside the valve housing when the flexible member is in its first state.

According to one aspect, in the valve according to any preceding and/or subsequent aspect, the flexible member has a U-shaped cross-section formed by at least one side wall forming the legs of the U-shape and a solid bottom forming the base of the U-shape and is configured to be introduced into the second valve housing end until the solid bottom abuts the second valve housing end and to be detachably attached to this second end to sealingly close off this second valve housing end as a lid/plug. This reduces the number of parts making up the whole valve or dispensing device. This provides easy disassembly facilitating cleaning all the surfaces of the valve. In another aspect, the flexible member has a cup shape. In one aspect, the flexible member has its surfaces, in particular its inner surfaces, contacting liquid substance/water shaped with rounded contours or sufficiently large radius/radii. The same goes for other surfaces of the valve, in particular inner surfaces and bottom of its flexible member, but also its top end contacting the content of a container. This is done to eliminate too sharp corners or the like where dirt and/or contaminations can attach/build-up and form undesired locations of germs/bacteria forming biofilms thereon and to enhance the cleaning of those surfaces by detaching the flexible member and other valve components for thorough disinfection/cleaning. In yet one aspect, the inner surface/corners of the bottom of the flexible member has/have a radius of at least 3 mm for the same reasons.

According to one further aspect, in the valve according to any of the above and/or below aspects, the flexible member comprises a malleable wall section or side wall configured to sealingly abut/contact against the at least one valve housing outlet from inside the valve housing when the flexible member is in its first shape by being at least partly rounded to sealingly fit/abut/engage/contact against the inside of at least one side wall of the valve housing being at least partly rounded in a corresponding manner as the malleable section of the flexible member to achieve matching rounded sealing surfaces. This improves sealing due to the inner pressure of the content of the container.

According to still an additional aspect, in the valve according to any preceding and/or subsequent aspect, the second outlet or orifice of the external hollow protrusion (with the second liquid substance/water inlet) is configured to end inside the valve housing at an inner distance measured inwards from the first valve housing end. This improves emptying of the container as a distinct distance between the upper opening at the free end of the second liquid substance/water inlet and the lower opening of the second liquid substance/water inlet is achieved securing a difference in content level or height or length or volume incurring different pressures there between.

According to yet a further aspect, the valve according to any preceding aspect is adapted to let liquid substance and/or water entering the first liquid substance/water inlet of the valve to flow into the valve housing at a first distance measured from the first valve housing end in the longitudinal and/or axial direction of the valve housing and adapted to let the liquid substance and/or water enter the second liquid substance/water inlet of the valve to flow into the valve housing via the second outlet or orifice at a/the second inner distance measured from the first valve housing end in the longitudinal and/or axial direction, wherein the first inner distance is larger than the second inner distance. This improves emptying of the container as a distinct difference in distance between the first and the second inner distance enables incurring different pressures there between, whereby air entering the valve housing is led/guided towards the lower pressure of the second liquid substance/water inlet of the valve.

According to one aspect, in the valve according to any preceding aspect, the first liquid substance/beverage/water inlet of the valve is configured to form a first orifice of a first inner hollow channel or protrusion or tubular protrusion with a through hole extending into the valve housing to enable liquid substance and/or beverage/water to flow into the valve housing and the second liquid substance/water inlet of the valve is configured to form a first orifice of an external hollow/second channel or protrusion or tubular protrusion with a through hole extending into the valve housing to enable liquid substance and/or beverage/water to flow into the valve housing, wherein the through hole of the first inner hollow channel or protrusion has an inner size measured in the radial or crosswise direction of the valve housing/dispensing direction or measured in a direction in parallel with the plane of the first valve housing end being larger than the corresponding inner size of the through hole of the external hollow/second channel or protrusion. This improves emptying of the container as a distinct difference in size/volume for holding/containing/letting through flow of content via the second liquid substance/water inlet and its channel compared to the first liquid substance/water inlet and its channel is achieved securing that any air flows through the smaller sized passageway of the second liquid substance/water inlet and its channel and into the container instead of the first liquid substance/water inlet and its channel as the air would then have to pass more/a larger volume/height or longer path of content flowing in the opposite direction there through.

The valve is useful for being associated with a container filled with substance and/or water and having a discharge end with an opening configured for fluid communication with and detachable connection to the valve according to one or more of above and/or below aspects, which valve is actuable to selectively release and/or stop flow of liquid substance and/or water out of the container. Such an association is referred to as a permanent or replaceable or ex-changeable kit. The kit achieves the advantage of preassembly of container and valve for intermediate storage and/or quicker exchange between a container emptied on liquid/water and a new filled/full container as the valve is detachably preassembled on the container. This facilitates maintaining a high level of hygiene as preassembly of container and valve can be done in a hygienically controllable environment before the filled container with valve assembly, is delivered further, e.g. to an industry complex or the like with less control regarding hygiene standard in its environment when replacing an emptied container, i.e. the replaceable/exchangeable kit having an empty container, with a new kit with a filled one.

Further objects, features and advantages of the present invention will appear from the following definitions of aspects/examples thereof.

The container can be filled with liquid substance and/or water before the dispenser/valve is detachably connected to the container. This achieves the advantage of selecting separate storage of a container and a valve or storing them together before preassembling them. This enables the container and valve to be stored separately and then optionally be preassembled in a hygienically controlled environment as one replaceable/exchangeable kit before this kit, i.e. a filled container with valve, is transported further or be preassembled into one replaceable/exchangeable kit during the transport, e.g. to an office or industry area or the like with less control on the hygiene standard in its environment when replacing an emptied container of a first kit with the new filled one in a second kit. This also enables in some aspects to seal the container air-proof/airtight/hermetically after filling it and before the valve is detachably connected to the filled container.

The container can be placed in an upright position before or at or when the valve is detachably connected to the container. This achieves reducing the risk of spillage of liquid/water when coupling the valve to the container and easier preassembly of the container and the valve into the replaceable/exchangeable kit. This enables in some aspects, if the container comprises some kind of sealing, to postpone breaking its sealing to just before or at or when the valve is detachably connected to the container.

The valve according to one or more aspects as defined above and below can be used with a dispenser mounting that interchangeably receive a replaceable/exchangeable kit comprising the valve associated with a container, and a regulating unit/device or regulator to be actuated by the user to control/select dispensing or stopping liquid substance/water flow from the container via the valve according to any of the preceding or below aspects, the dispenser mounting being arranged to detachably support/hold the container with its valve according to one or more of the above and below aspects in a dispensing position. This achieves effortless and more secure assembly of the replaceable/exchangeable kit with container and valve while reducing user efforts by lessen the burden to hold, direct and align the whole kit, i.e. container and valve assembly into engagement with the regulating unit/regulator. This reduces spillage of liquid/water when coupling a new replaceable/exchangeable kit with a filled container to the dispenser mounting (after decoupling a used one with an emptied container).

The dispenser mounting can be configured to receive the replaceable/exchangeable kit with the container discharge end having the connected valve according to any above and/or below aspect to operatively engage the regulating unit/device/regulator. This reduces the effort for the user and enable a safer assembly of the replaceable/exchangeable kit with container/valve as the dispensing mounting aids in supporting, directing and aligning the whole kit with container and valve into secure/reliable engagement with the regulating unit or regulator making the handling of all entities more robust and eases a guaranteed operation thereafter.

The container of the replaceable/exchangeable kit can be placed in an upright position with its discharge end pointing upwards in the dispenser mounting before or at or when the valve according to any above and/or below aspect is detachably connected to the container. This reduces risk of spillage of liquid/beverage/water when coupling the valve to the container as a replaceable/exchangeable kit by stabilising and supporting the weight of the container and then the full kit.

The container of the replaceable/exchangeable kit can be turned over from an upright position into a position with its discharge end pointing downwards before operatively connecting the regulating unit/device/regulator and the valve according to any above and/or below aspect. This reduces the risk of non-controllable flow of liquid/water out of the container as the valve of the replaceable/exchangeable kit is filled with liquid substance or beverage or water in liquid form before engagement with the regulating unit or regulator of the dispensing mounting, i.e. any undesired air inside the valve housing is minimized or even totally eliminated, whereby a smooth and uninterrupted or continuous flow of liquid/water out of the container at the first moment of dispense and during the whole dispensing process until the dispensing is ended/stopped is secured.

In any of the above and/or below aspects, the closed container is either stiff and non-compressible (at least during dispensing of its content at the present pressure used/incurred in this application) or relatively stiff but at least somewhat flexible/compressible (to be able to shrink/be compressed at least somewhat during dispensing of its content at the present pressure used/incurred in this application).

In any of the above and/or below aspects, the valve and/or valve housing has a varying outer/external shape or size or width or thickness or diameter along its length, wherein a first/top portion of the valve housing along its length as measured from its first/top end towards and to a middle portion at or adjacent its external flange or edge has a first valve housing size or width or thickness or diameter and a second/bottom/end portion of the valve housing along its length as measured from its second/bottom end towards and to a middle portion at or adjacent its external flange or edge has a second valve housing size or width or thickness or diameter, which sizes or widths or thicknesses or diameters are equal or different.

These sizes or widths or thicknesses or diameters are measured substantially perpendicularly or perpendicularly to the length or longitudinal direction or centre axis of the valve housing. These sizes or widths or thicknesses or diameters are measured in a substantially radial or a radial direction relative the length or longitudinal direction or centre axis of the valve housing.

In any of the above and/or below aspects, the first valve housing size or width or thickness or diameter is smaller or larger than the second size or width or thickness or diameter.

In any of the above and/or below aspects, the first valve housing size or width or thickness or diameter is smaller than the second size or width or thickness or diameter.

In one or more of the above and/or below aspects, the first valve housing size or width or thickness or diameter is larger than the second size or width or thickness or diameter.

The above aspects of a valve having a varying outer/external shape or size or width or thickness or diameter along its length enables adapting this valve to be applicable into discharge openings of containers having different sizes, i.e. small or large openings, by being able to introduce the first/top end of the valve into container openings of different sizes, while maintaining the functionality of smooth and vibration free dispensing and low throttling, i.e. low reduction in pressure or low pressure drop, by means of the advantageous design and optimised varying shape of the second/bottom/end portion of the valve.

Further objects and features of the present invention will appear from the following detailed description of aspects/examples of the invention.

### BRIEF DESCRIPTION OF THE DRAWINGS

The invention will be described in more detail with reference to the enclosed figures, which show examples of presently preferred embodiments of the invention.

FIG. 1 is a plane view of a liquid substance/beverage dispensing valve mounted onto a container of liquid substance, e.g. juice or ice tea or water according to an embodiment of the disclosure.

FIG. 2 shows the liquid substance/beverage dispensing valve of FIG. 1 in a state being disassembled from the water container or during/before assembly to the liquid substance or beverage container from one side with a dispense/discharge opening/outlet facing out of and towards the viewer in its non-dispensing mode, i.e. closed.

FIG. 3 shows the liquid substance/beverage dispensing valve of FIG. 2 from another side with a dispensing or discharging opening/outlet turned 90° to the left in its non-dispensing mode.

FIG. 4 shows the liquid substance/beverage dispensing valve of FIG. 2 from above.

FIGS. 5A and 5B show the liquid substance/beverage dispensing valve of FIGS. 2 and 3 corresponding to the FIG. 3 view in section along line A-A in FIG. 2 in its non-dispensing mode.

FIG. 6 shows the liquid substance/beverage dispensing valve of FIG. 2 with its dispense or discharge opening/outlet facing out of and towards the viewer in a dispensing mode, i.e. open for dispense/discharge of liquid substance/beverage therefrom.

FIGS. 7A and 7B show the liquid substance/beverage dispensing valve of FIGS. 5A and 5B, respectively, in a dispensing mode, i.e. open for dispense/discharge of the liquid substance or beverage therefrom.

FIGS. 8A and 8D show the liquid substance/beverage dispensing valve of FIGS. 5A and 5B, respectively, from above, i.e. in section along line C-C in FIG. 2 in its non-dispensing mode, i.e. when closed for not enabling dispense/discharge of the liquid substance/beverage therefrom.

FIG. 8B shows the liquid substance/beverage dispensing valve of FIGS. 5A and 7A from above, i.e. in section taken along line C-C in FIG. 2 in a state between its non-dispensing mode, i.e. when closed for not enabling dispense/discharge of liquid substance/beverage therefrom, and a fully open position/mode being the full dispensing mode, i.e. fully open for dispense or discharge of liquid substance/beverage therefrom.

FIG. 8C shows the liquid substance/beverage dispensing valve of FIGS. 5A, 7A and 8B from above, i.e. in section along line C-C in FIG. 2 in Its fully open position/mode being a full dispensing mode, i.e. fully open for dispense/discharge of liquid substance/beverage therefrom.

FIG. 8E shows the liquid substance/beverage dispensing valve of FIGS. 5B, 7B and 8D from above, i.e. in section taken along the line C-C in FIG. 2 in its fully open position/mode being the full dispensing mode, i.e. fully open for dispense/discharge of liquid substance/beverage therefrom, i.e. from the container.

FIG. 9 shows the liquid substance/beverage dispensing valve of FIGS. 1 to 4, 5A, 8A in an exploded perspective view as disassembled in itself and from the container or during/before assembly of itself and to the container with its dispense/discharge opening/outlet facing to the left in its non-dispensing mode, i.e. closed.

FIG. 10 shows the dispensing valve of FIGS. 1 to 4, 5B, 8E in an exploded perspective view as disassembled in itself and from the container or during/before assembly of itself and to the container with its dispense/discharge opening/outlet facing to the left in its full dispense mode, i.e. fully open.

FIGS. 11A and 11B show the dispensing valve of FIGS. 1, 5B, 7A, 7B, 8C and 8E in perspective assembled in itself but not to the container or during/before assembly to the container with its dispense/discharge opening/outlet facing to the left in its full dispense mode/fully open.

FIG. 12 shows a sectional plan view of the upper part, i.e. housing of the dispensing valve of FIGS. 9 and 10 without the lower part in these figs. with a varying shape along its length according to an embodiment of the disclosure.

FIG. 13 shows in an upper plan view of the container of FIG. 1 separately/before assembly to or after disassembly from a holder/dispenser mounting shown in the lower view of FIG. 13.

FIG. 14 shows in a plan view the container of FIGS. 1 and 13 during assembly/disassembly from the dispenser mounting of FIG. 13 and the dispensing valve of FIGS. 1 to 12 before assembly to the container/after disassembly from the container in two different upside down views, the upper left view is a sectional one and the upper right view is a plan view showing a connector of the valve enabling detachable connection of the valve to the container.

FIG. 15 shows in a plan view the container of FIGS. 1, 13 and 14 during assembly/disassembly from the dispenser mounting of FIGS. 13 and 14 with the valve of FIGS. 1 to 12, and 14 assembled to the container with the container upside down before being turned 180° and placed/introduced into a dispensing position in the dispensing mounting of FIGS. 13 and 14.

FIG. 16 shows in a plan view the container of FIGS. 1, 13, 14 and 15 after assembly or before disassembly from the dispenser mounting of FIGS. 13, 14 and 15 after the container is turned 180° from the position of FIG. 15 being a dispensing preparing state and being introduced into a start position before initiating dispensing.

FIGS. 17A-17D is plan views showing a liquid substance/beverage/water dispensing system in different phases of dispensing, i.e. FIG. 17A shows the start or newly started dispensing; FIG. 17B shows the dispensing after a certain time; FIG. 17C shows the dispensing after a certain longer time, and FIG. 17D shows the final stage or ending/end position after dispensing with a fully emptied container before replacing it with a new filled one in a procedure.

FIG. 18 shows the valve according to an embodiment of the invention in an exploded view before assembly or after disassembly of the parts making it up.

FIG. 19 shows the valve of FIG. 18 assembled from one side.

FIG. 19A shows a dispensing valve in perspective assembled in itself but not connected to the container or during/before assembly to the container with its dispense/discharge opening/outlet facing to the right in its non-dispensing mode/fully closed according to an embodiment of the disclosure.

FIG. 20 shows the valve of FIGS. 18 and 19 assembled from another side, i.e. turned 90° around its centre/longitudinal axis.

FIG. 21 shows a part of the valve for detachable connection to the container, this part being made of two detachable halves configured to be laid around a first portion of the valve and connected together into a valve envelope surrounding common part that is adapted to be threaded onto the container discharge end according to an embodiment of the disclosure.

FIGS. 22 to 24 show parts according to other embodiments of the disclosure, which parts are configured to cooperate with the valve enabling regulating the flow of water out of the container by opening and closing the valve and guiding the flowing water correctly.

FIGS. 26A and 26B show different states of the dispensing in more detail, i.e. FIG. 26A shows the ending of the dispensing and FIG. 26B shows the start of dispensing or an intermediary phase of dispensing or a full dispensing phase for better understanding thereof according to embodiments of the disclosure.

FIGS. 26C and 26D show some of the parts physically enabling the dispensing in more detail, i.e. FIG. 26C corresponds to the dispensing phases of FIGS. 7A, 7B, 8B, 8C, 8E, 10, 11A, 11B, 17A-17C, 26B (curved two-way arrows in FIG. 26C visualise pivoting/rotary movement of parts while the straight two-way arrow to the right visualises an area of an embodiment of the valve along which another entity shown in FIGS. 22, 23, 26A and 26B moves or slides when engaged) while FIG. 26D shows in solid lines the none-dispensing phase or end position of FIGS. 1, 3, 5A, 5B, 8A, 8D, 16, 17D and 26A and a part (shown both in solid and dotted lines) being movable back and forth according to the solid two-way arrow visualising an inwards direction (upwards in FIG. 26D) for dispense and one outward direction (downwards in FIG. 26D) for decreasing flow of dispensed liquid until the position shown in the solid lines is reached ending the dispensing with some parts removed and in larger scale for clarity.

### DETAILED DESCRIPTION

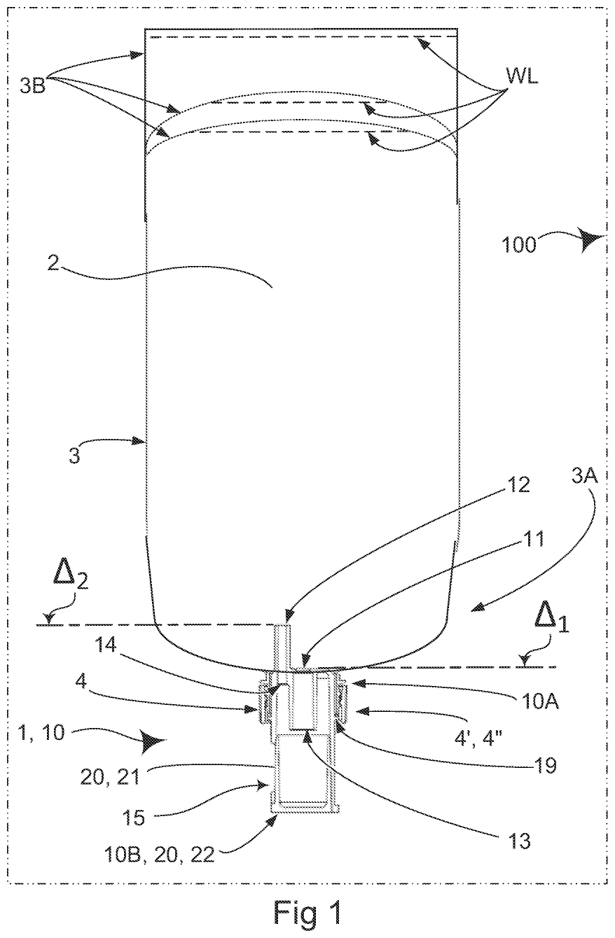

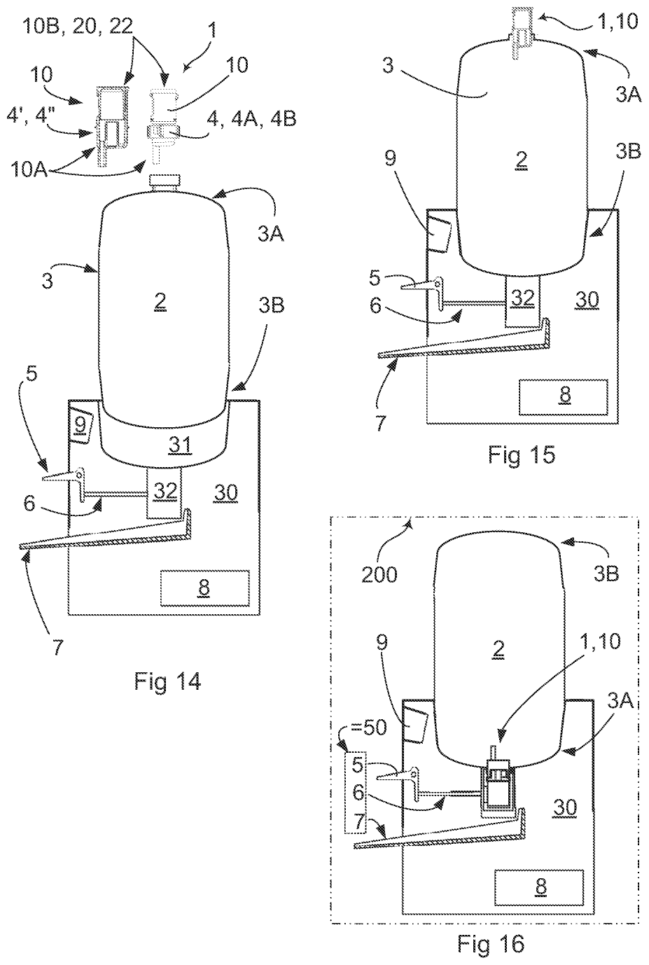

A device is shown in FIGS. 1-26D comprising a valve 1 according to aspects of the disclosure.

The device is intended to enable dispense of liquid substance 2, such as liquid foods or beverages 2, e.g. juice, such as apple juice, orange juice, ice tea or the like besides a preferred drinkable liquid being water 2, and/or liquid soap or detergents or personal care products in liquid form from a stiff, in principle, non-compressible container 3 or a relatively stiff but at least partly flexible or compressible container 3. The liquid substance 2 is in fluid or liquid form. The dispensing of the liquid substance 2 is done by means of gravity as the container 3 has an opening at its bottom as seen in FIG. 1. The device 100 of FIG. 1 according to an aspect of the disclosure comprises the valve 1 with a hollow valve housing 10. The valve 1 comprises a flexible member 20 adapted for detachable assembly to the valve housing 10. For simplicity, water 2, 2′, 2″ in liquid form will be used as example when explaining the invention through-out the description, even though any other of the mentioned examples of liquid substances 2 is likewise possible to dispense by means of the valve 1.

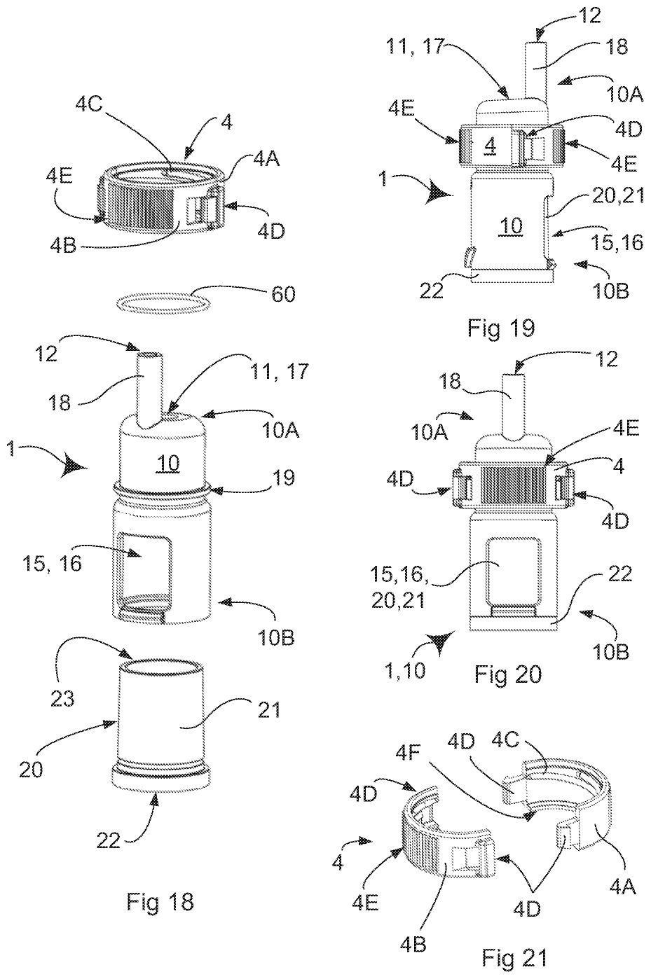

In FIG. 1, the device 100 is shown as a system or assembly or kit comprising the container or bottle 3 detachably connected by means of a connector 4, 4′ at the valve end 10A. The connector 4 in an embodiment is shown at least in FIGS. 18, 19, 20 and 21, such as a nut 4 that is detachably screwed onto a thread of the container 3 after being slid over the valve 1 or a connector 4′ or fitting 4′ in another embodiment is shown in at least FIG. 19A comprising one or more sealings 4″, preferably at least two sealings, e.g. in the form of o-ring/-s and/or packing ring/-s, fitted/arranged in grooves around the external envelope surface of the connector 4′ at the valve end 10A, which connector 4′ is pushed into the neck of the container until it bottoms with flange 19 and then the sealings 4″ are configured to press outwards radially against the inner surface/circumference of the container 3 in a way that guarantees sufficient and leakproof sealing, to the valve 1. This is for connector 4 done in a way that guarantees sufficient and leakproof sealing to the valve 1 as the nut 4 engages over an outer flange or edge 19 being part of or integrated in the valve housing 10 and pushing on this flange while threaded onto the container 3 until the whole valve 1 comes into sealed engagement with the opening of container 3 and its content of water 2 when the container is turned upside down. The valve 1 is shown in FIG. 1 with its flexible member 20 in a first state or shape closing the valve 1 and thereby hindering flow of water out of the bottle 3.

In the embodiment of connector 4′ in FIG. 19A, the valve housing 10 comprises a slanted part 10F below the opening and outlet 15. This slanted part 10F could be used in other embodiments, e.g. in the ones shown in the other figs. This slanted valve housing part 10F is achieved by either making a bevel or chamfer after moulding the valve 1 or providing the mould with a shape that creates this slanted/bevelled part 10F when/after moulding. This slanted valve housing part 10F is in some embodiments a portion of the valve housing wall having a thinner or its thinnest wall thickness at its highest point being closest and/or forming the lower part of the orifice/opening of outlet 15 and a thicker or its thickest wall thickness at its lower or lowest point being closer/closest to bottom end 10B and/or forming part of bottom end 10B. Transition between the thinner and thicker portions of the slanted valve housing part 10F is smooth and may be done at/with a suitable angle. The slanted valve housing part 10F has a purpose of eliminating or at least reduce any liquid/water and/or dirt being left on or remaining on the shelf-like lower part of the outlet 15 at use and/or after dispense to improve hygiene and/or reduce leakage/dripping of liquid/water after finishing dispensing.

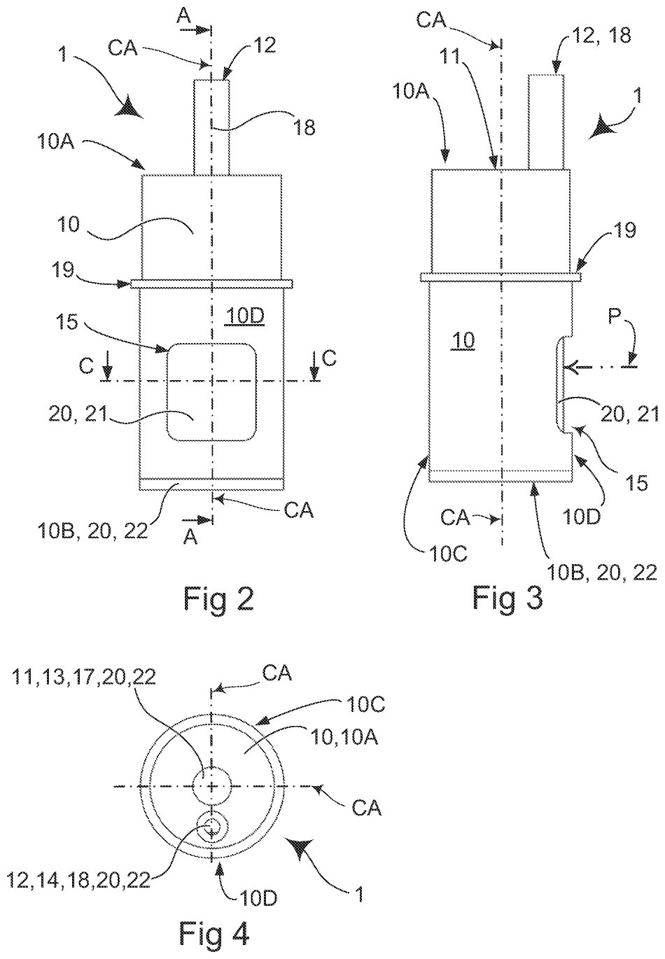

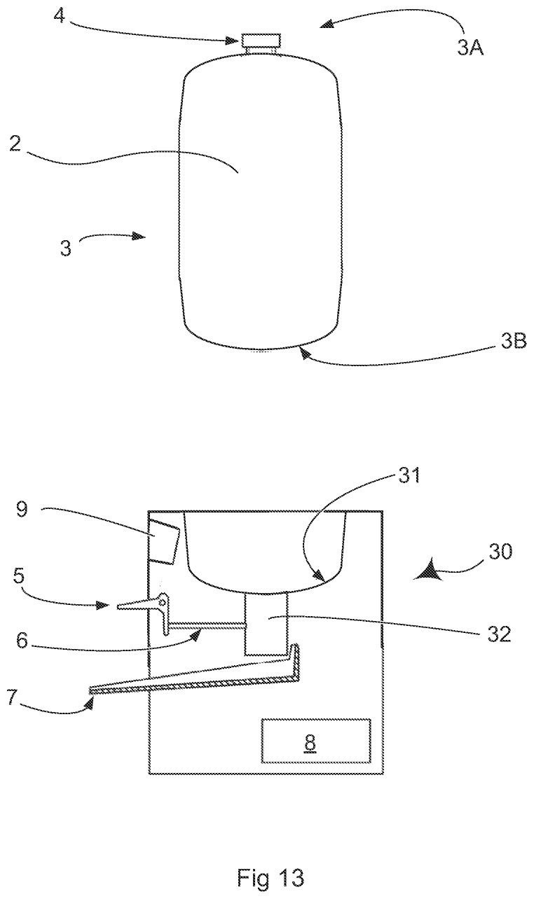

In FIGS. 1 and 19A, the connector 4′ is adapted for detachable and sealed press fitting connection by means of the sealing/-s 4″ to detachably connect the valve 1 to the container 3 after being pushed into the opening of the container 3 at its discharge end 3A until the valve 1 comes into sealed engagement with the opening of container 3 and its content of water 2 or the like when the container is turned upside down in a corresponding manner as shown in steps of FIGS. 13 to 17D. The valve 1 and its housing 10 with connector 4′ comprises one or more outer protrusions 10E at its envelope surface between an outlet 15 and inlets 11, 12. Outer protrusions 10E are guides for the valve 1 when assembled. The embodiments of the connector 4, 4′ in FIGS. 1, 5A, 5B, 7A, 7B, 11A, 11B, 12, 14, 15 and 18 to 21 has a rounded upper shape or top (a larger circumferential radius) at the valve housing end 10A compared to embodiments of the connector 4 in FIGS. 2 to 4, 6, 9, 10, 16, 17A to 17D, 26A and 26B. In some embodiments, the more rounded shape of the upper end of connector 4, 4′ is advantageous as less material is needed for manufacture and/or there is less risk of having liquid/water and/or dirt remaining on the top end 10A when a container 3 is emptied and to be replaced.

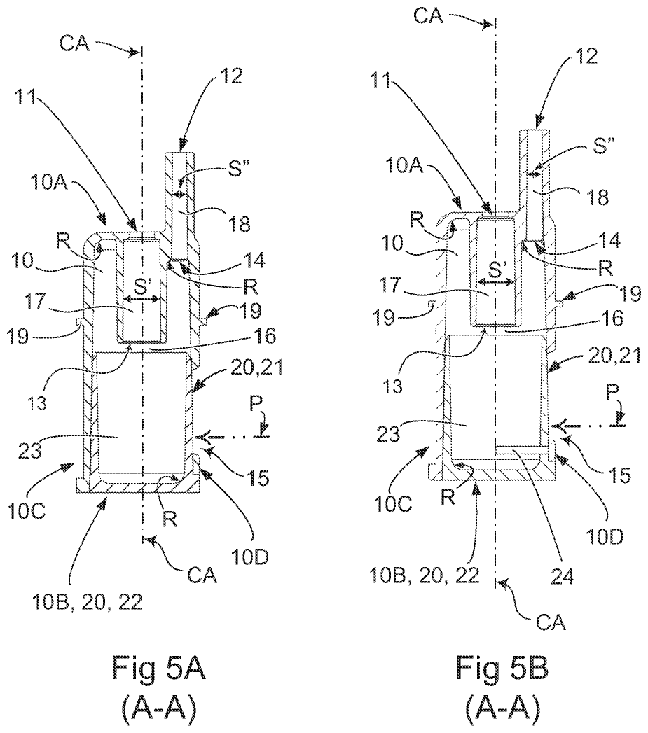

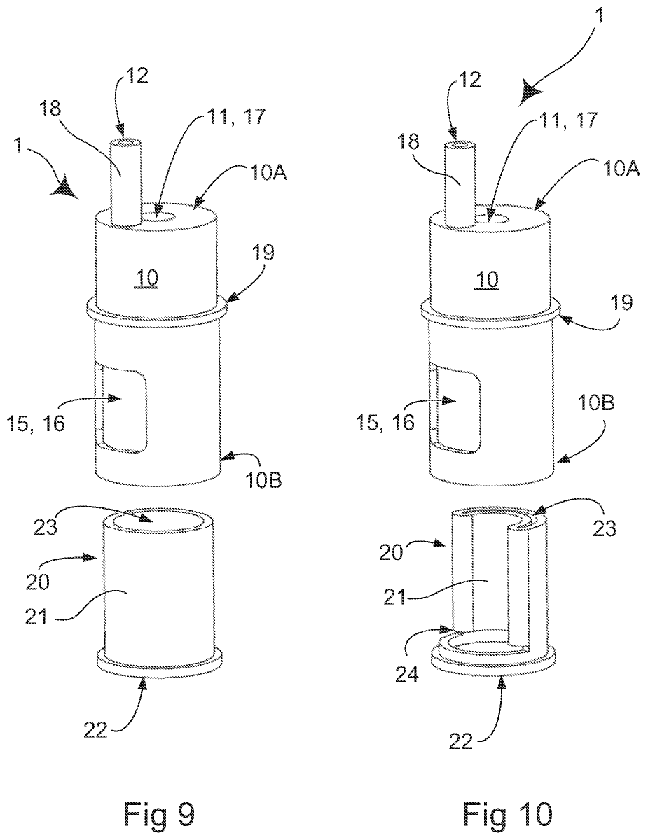

In FIGS. 5A, 5B, 9 and 10, the flexible member 20 is shown substantially shaped as a cup with a U-shaped cross-section. As shown in FIGS. 9 and 10, the flexible member 20 is configured to be introduced into or taken out of the valve housing 10 at one of its ends 10B. Flexible member 20 detachably seals this valve housing end 10B as a plug or lid when assembled thereto. The valve housing 10 also has a centre axis CA as shown in FIGS. 2 to 4, 5A, 5B, 6, 7A, 7B, and 8A to 8E to more clearly define its shape and extension and use. The flexible member 20 could be part of or integrated into the valve housing end 10B and not necessarily be a separate and detachable part, e.g. one of its parts 21 could be an openable/closeable wall of the valve housing 10 inside an outlet 15 of the valve housing 10 similar to a window or curtain or hinged lid, e.g. by cutting-out/slitting through a part of the housing wall. This outlet 15 enables access from externally of the valve housing 10 into its inside and the flexible member 20 therein. This outlet 15 forms an external outlet of the valve housing 10.

The valve housing 10 in FIGS. 2 to 4, 5A, 5B, 6, 7A, 7B, and 9 to 11B comprises a first or top end 10A and above bottom or second end 10B and a first side 10C and a second side 10D. In FIGS. 1, 2, 3, 5A, 5B, 6, 7A, 7B, the valve housing 10 is shown either at least partly or fully square-shaped and/or at least partly rounded or fully rounded along its longitudinal direction/length, while the valve housing 10 in FIGS. 4, 8A to 8E, 9, 10, 11A, 11B, 12, 14 -21, 26A and 26B is rounded or cylindrical. The valve housing 10 of any of the above and below aspects could be at least partly square and/or rectangular at one or more of its sides 10A-10D and be at least partly rounded and/or cylindrical at one or more of its other sides.

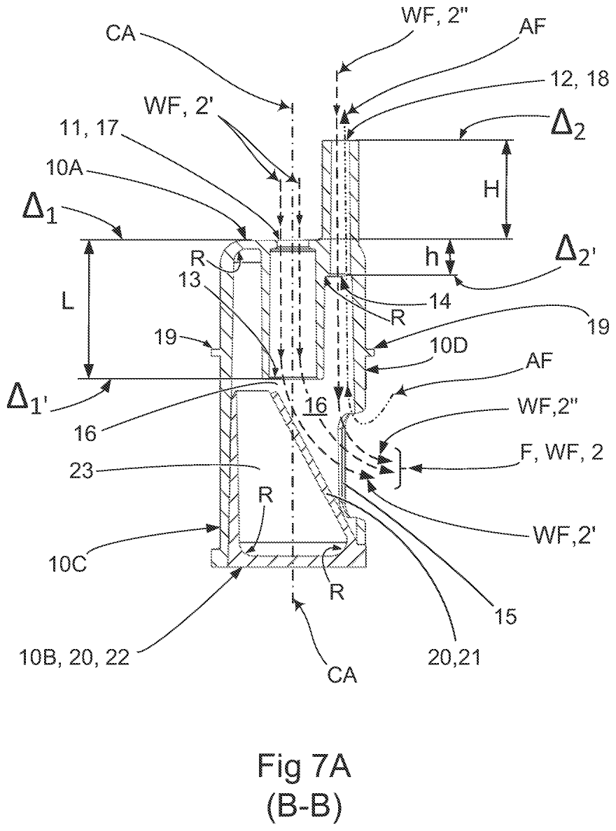

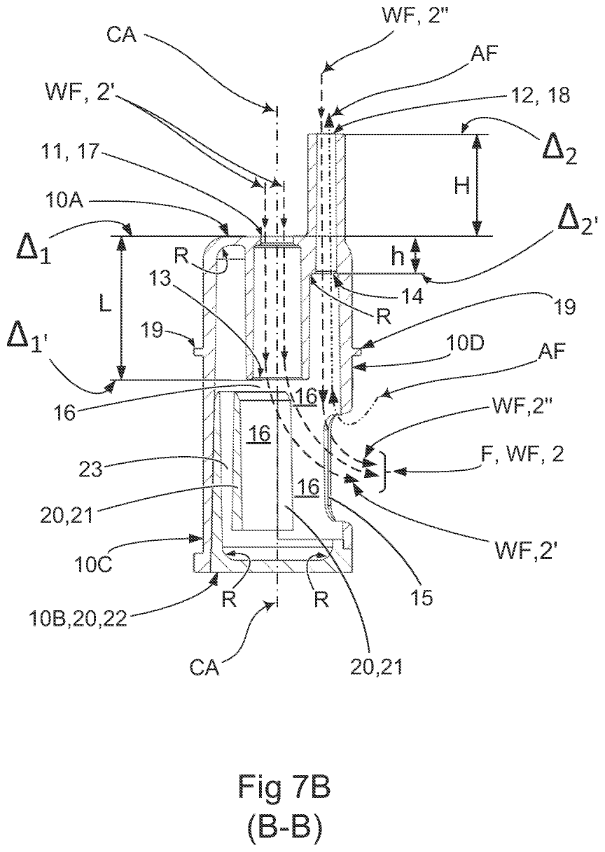

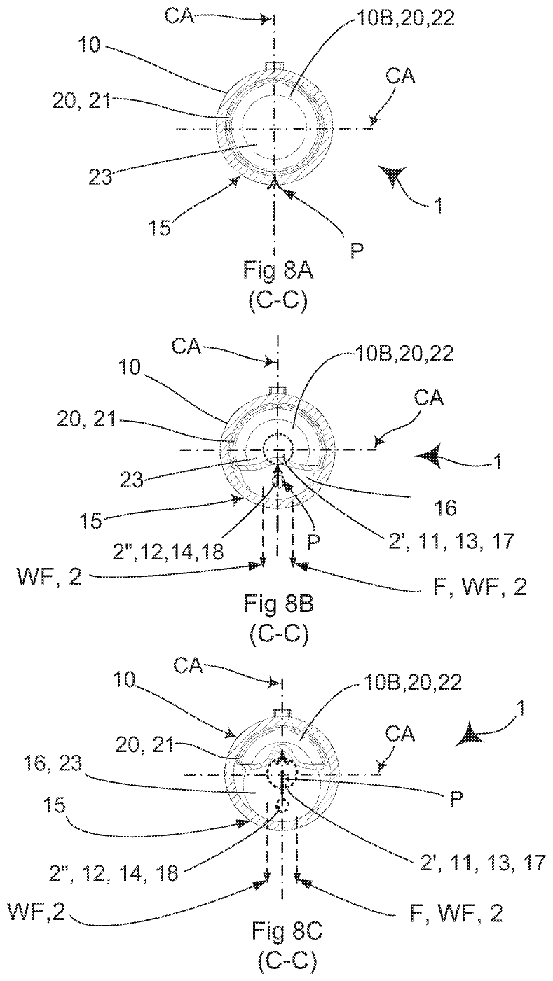

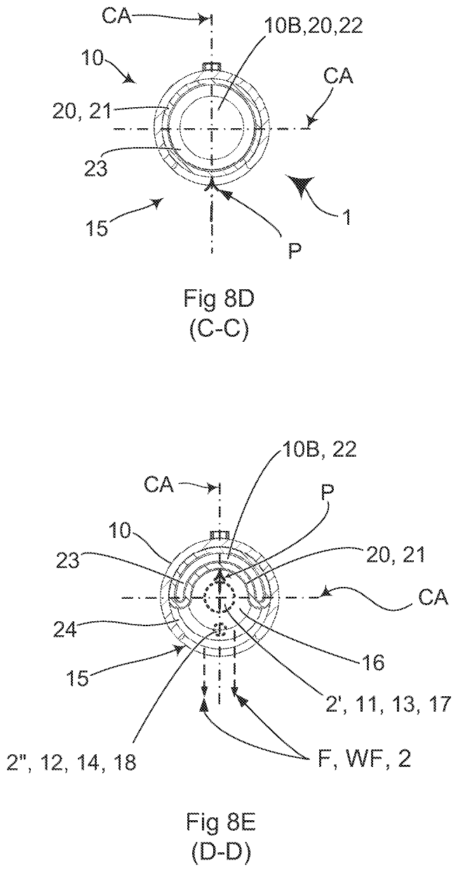

The container 3 is made of a material with the ability to not change its shape, i.e. being sufficiently stiff, or to change shape or at least partly collapse when the water 2 is discharged by opening the valve 1 of the device 100, whereby water 2 flows out as a water flow WF by means of gravity while air as an air flow AF is let in to the container 3, see FIGS. 7A, 7B, 8A and 8B. The valve housing 10 comprises two openings or inlets 11, 12 for the water flow WF at its top end 10A. At least one of those upper inlets 11, 12 is configured to let in the airflow AF into the container 3. The valve housing 10 comprises at least one other opening or outlet 15 at and through its side 10C or 10D. The outlet or opening 15 is made through the thickness of valve housing 10. The container 3 is made of plastic material with barrier properties, which guarantee that water 2 can be stored in the container airtight/airproof and for a longer period of time at room temperature without risk of bacterial effects. The plastic material from which the container 3 is made is in the form of a plastic foil with special properties, such as PET or the like plastic material fulfilling food product storage demands, while being sufficiently stiff and non-compressible to not change shape during dispensing or be sufficiently pliable or flexible to at least partly change shape during dispensing to require exchanging container content against air when dispensing the liquid substance 2, 2′, 2″.

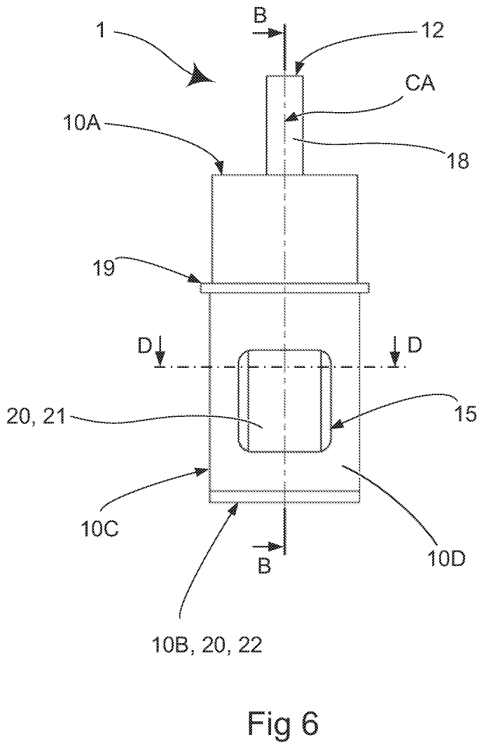

The flexible member 20 is configured to seal against the inside of the valve housing 10 when assembled therein and to abut against an inner seat of the valve housing around the inside or inner rim or orifice of its opening 15. The flexible member 20 is therefore partly exposed with a part 21 through the fenestrated valve housing 10. This flexible member part 21 is accessible from the outside of the valve housing 10. The valve 1 is adapted to be opened by applying an external pressure P onto the exposed flexible member part 21 as shown in FIGS. 5A, 5B, 8A to 8E, 17A to 17C, 26B and 26C. The shape of the flexible member 20 in FIGS. 8A, 8B, 16, 17D, 19, 20 and 26A corresponds to its shape in FIGS. 1, 3, 5A, 5B, and 9, i.e. an end state closing the valve 1. The other shape of the flexible member 20 in FIGS. 8C and 8E corresponds to the shape in FIGS. 6, 7A, 7B, 10, 11A 11B, 17A-17C, 26B, 26C, i.e. an end state opening the valve 1 fully for a full “throttle” of water flow WF, 2 out of the container 3. This shape of flexible member 20 in FIG. 8B is not shown in any other figure and corresponds to a middle or intermediary or transcending shape between the other two end shapes/states of flexible member 20 by which the valve 1 is at least partly opened to start letting out or is letting out at least a part of the full water flow WF, 2 from the container 3.

The valve 1 is adapted to dispense water 2, 2′, 2″ from container 3 in the dispensing or flow direction WF. Water 2, 2′, 2″ is let in at the first end 10A. The valve 1 comprises the valve housing 10 with the second end 10B. The valve housing 10 is hollow and/or comprises a cavity. Water 2, 2′, 2″ is let out and/or dispensed at the second end 10B. At least one or both inlets 11, 12 for water 2, 2′, 2″ is arranged at the first valve housing end 10A. These inlets 11 and 12 are externally arranged of the valve housing 10 and intended to be internally arranged in the container 3 when the valve 1 is detachably and leak-proof coupled thereto. These inlets 11 and 12 have their mouths or openings outside of the valve housing 10 but inside the container 3 when the valve is detachably and leak-proof mounted thereon. At least one outlet 13, 14, 15 for the water 2, 2′, 2″ is arranged at/closer to the second valve housing end 10B than the inlets 11, 12. The outlets 13 and 14 are arranged internally of the valve housing 10. The outlets 13 and 14 are inner outlets of the valve housing 10. The outlets 13 and 14 have their mouths or openings or orifices inside the valve housing 10. The in-/outlets 11, 12, 13, 14, 15 are configured to be in fluid communication via at least one inner passageway 16 through the valve housing 10. The valve 1 further comprises the flexible member 20 sealingly fitted into the valve housing 10. The flexible member 20 is configured so that it is possible to change and/or alter its shape from at least one shape to another, either stepless, gradually, variably or infinitely variable and/or in steps and/or using a snap-functionality. The flexible member 20 is at least partly hollow and/or comprises at least partly a through hole/channel and/or is tubular for enabling water 2, 2′, 2″ to be received and/or flow through it. The flexible member 20 is shape-changeable between a first state/step/shape closing off the inner passageway 16 and a second state or step or shape opening up the inner passageway. In the second state or step or shape, the flexible member 20 enables dispensing water 2, 2′, 2″ from the at least one valve housing inlet 11, 12 via the passageway 16 out of the at least one outlet 15. In the first state or step or shape, the flexible member 20 sealingly closes off inner passageway 16 for hindering dispense of water 2, 2′, 2″ out of valve 1, i.e. via the inner passageway 16 out of the at least one valve housing outlet 15.

The valve 1 comprises at least a first inlet 11 and at least a second inlet 12, which inlets are configured for receiving and/or letting water 2, 2′, 2″ into the valve housing 10 and its inner passageway 16. In some embodiments, the first valve inlet 11 is adapted to receive/let at least a part flow 2′ of the whole/full water flow 2 into the valve housing 10 and its inner passageway 16. In some embodiments, the first valve inlet 11 is adapted to receive/let almost the whole/full water flow 2 into the valve housing 10 and its inner passageway 16. The second valve inlet 12 is adapted to receive/let another or remaining part flow 2″ of the full/whole water flow 2 into the valve housing 10/inner passageway 16. In some embodiments, the second valve inlet 12 is adapted to receive/let almost the full/whole water flow 2 into the valve housing 10/inner passageway 16. In some embodiments, the water flow 2′ from the inlet 11 flows through an inner channel or protrusion 17 that is configured with this first inlet 11 as a first orifice. In some embodiments, this hollow inner protrusion 17 extends with a length L inside the valve housing 10 from its first end 10A towards its second end 10B. In some embodiments, the hollow inner protrusion 17 ends in a second orifice 13 at/adjacent/close to the upper part of the flexible member 20. This is done to enable water 2, 2′ to flow from the first inlet 11 through the inner hollow protrusion 17 and out of the second and inner orifice 13 and the at least one outlet 15 via the inner passageway 16 and the flexible member 20 when the flexible member is in its second shape or open state.

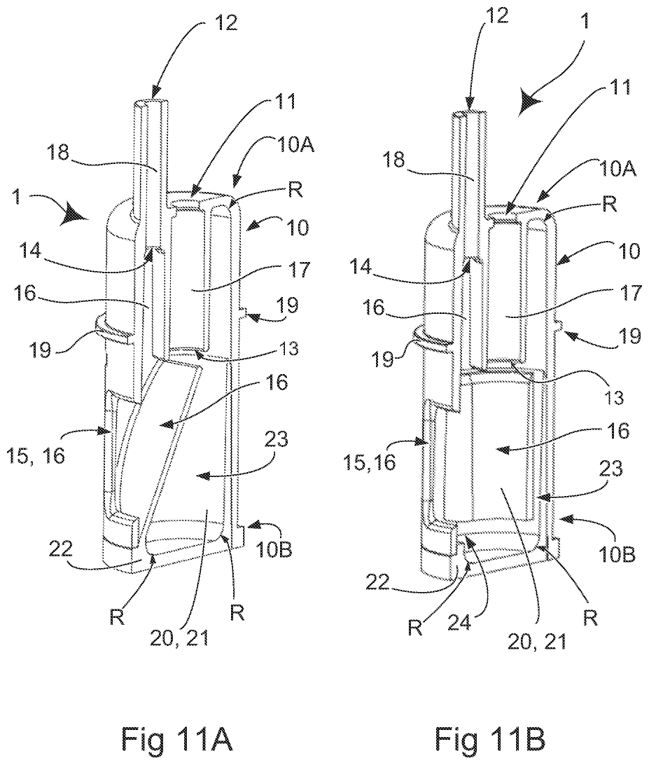

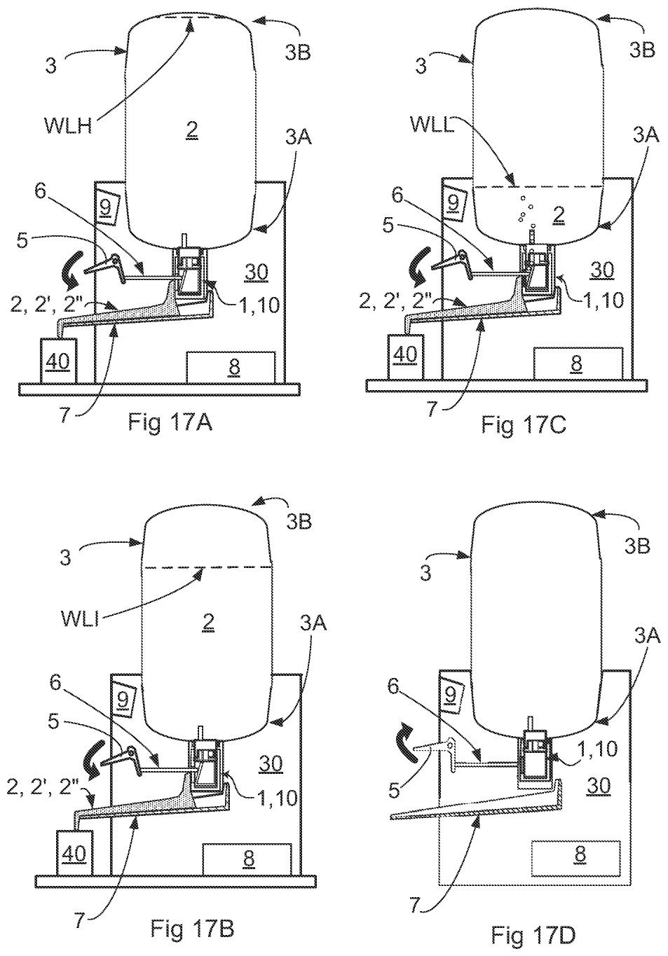

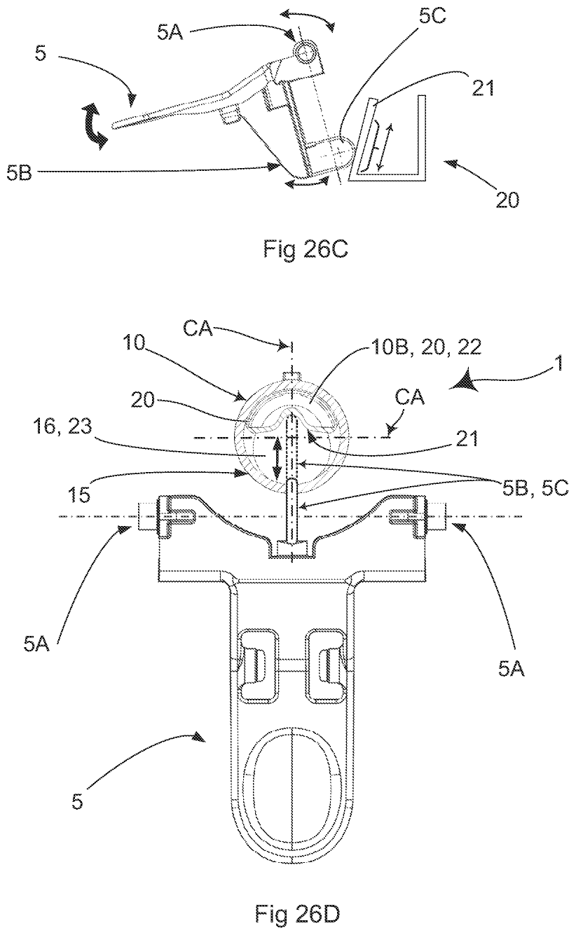

In FIGS. 5A, 7A, 8A to 8C, 9A, 11A and 18, one version of the flexible member 20 is shown with a U-shaped cross-section similar to a cup with a closed bottom 22. The cup-shaped flexible member 20 has an inner space 23 that has its largest volume when the valve 1 is closed (as in FIGS. 2, 3, 5A, 8A, 9, 16, 17D, and in FIG. 18 showing it not yet assembled into or just disassembled from its closed state, and FIGS. 19, 20 and 26A) and its smallest volume when the valve is fully open (as in FIGS. 7A, 8C, 11A, 26B, 26C). The inner space 23 forms a part of the inner passageway 16. When the flexible member 20 is pushed at its part 21 exposed through the opening 15 of the valve housing 10 by the external pressure P exerted by a finger or linkage or a handle or a lever 5 or a shaft 6 or the like (see FIGS. 13 to 17D and 26A to 26C). The lever 5 in one aspect pushes the shaft 6 of FIGS. 13 to 17D against the flexible member 20 and its shape-changing wall part 21 when dispensing is to be performed (the bent arrow to the left of the lever 5 of FIGS. 17A to 17D visualises this pushing). In FIGS. 17A to 17C and 26B and 26C the lever 5 is pushed downwards as the left arrow points and in FIG. 17D and 26A the lever 5 is pushed upwards as the left arrow points. In FIGS. 17A to 17C, 26B and 26C the valve 1 is thereby opened such that dispensing is initiated and beverage/water 2, 2′, 2″ flows out and into a chute or guide 7 for receiving and discharging liquid substance/beverage/water when dispensing. Hence, this embodiment of the flexible/elastic part 21 bends inwards from the side 10D of the valve housing towards its opposite side 10C (see start of pushing movement from the closed position in FIGS. 8A, 16, 17D and 26A into the intermediary position in FIG. 8B where the second inlet 12 is opened and further to the end position in FIG. 8C where the first inlet 11 is opened and the valve 1 is fully open for dispensing as shown in FIGS. 17C, 26B and 26C). As shown in embodiments of FIGS. 7A, 11A, 17A to 17C, 26B and 26C, the shape-changing wall part 21 of the flexible member 20 is deformed from a straight wall similar to a slope having a substantially or exactly 90° angle in relation to the horizontal plane in the closed state of the valve 1 as shown in embodiments of FIGS. 8A, 16, 17D, and 26A into an intermediary position similar to a wall or slope with an angle less than 90° but larger than 20° from the horizontal plane as shown in FIG. 8B and further into the fully open position of the valve 1 where the part 21 has reached its end position or end shape at an angle between about 70° and 20° from the horizontal plane as shown in FIGS. 7A, 11A, 17A to 17C, 26B and 26C. The deformable or malleable wall part 21 of the flexible member 20 has in this embodiment a rounded shape and therefore a variable bent shape or radius following its increasing and decreasing angle when opening and closing the valve 1 as is understood from FIGS. 8A, 8D and 8E. In embodiments of FIGS. 11A and 11B, the upper numeral for inner passageway 16 ends in an annular shaped inner chamber formed between the outside and/or envelope surface of the inner channel 17 and the inner surface of the upper section of the valve housing 10. This annular inner chamber is at least partly filled up or fully filled up with content of the container 3 when turned into the state of embodiments of FIGS. 16 and 17A to 17C and/or emptied and is in communication with the second inlet 12 via its second orifice 14 and inner channel 18.

In embodiments of FIGS. 5B, 7B, 8D, 8E, 10, and 11B, another version of the flexible member 20 is shown, which has the same features as the above version except for a slit 24 at a lower section of flexible member 20 closer/adjacent its bottom 22. The slit 24 is made through the wall of the flexible member in a direction substantially or exactly in radial direction of the valve housing 10 and flexible member 20 or in parallel with the plane of the bottom 22 of the flexible member. The slit 24 extends fully through the wall material of the flexible member 20 about half the thickness or width or depth or diameter or about the whole/full radius of the flexible member if it is rounded or circular or cylindrical. This slit 24 makes the flexible member 20 easier to deform if it has thicker walls than the other version or embodiment of the flexible member 20 or if it is made of a material being stiffer than the material of the other version or embodiment of the flexible member above. This slitting enables folding or bending the flexible member wall 21 in a radial direction instead of deforming it into a slope-like wall as in the other embodiment.

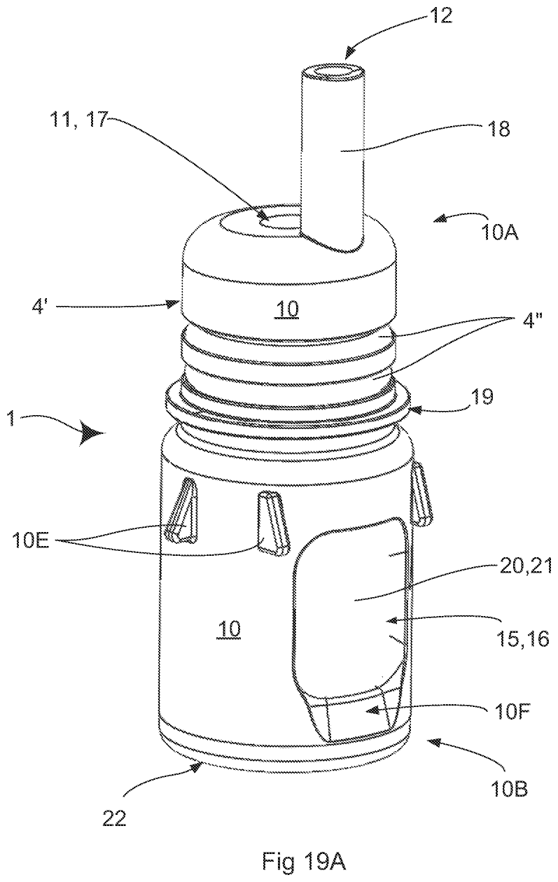

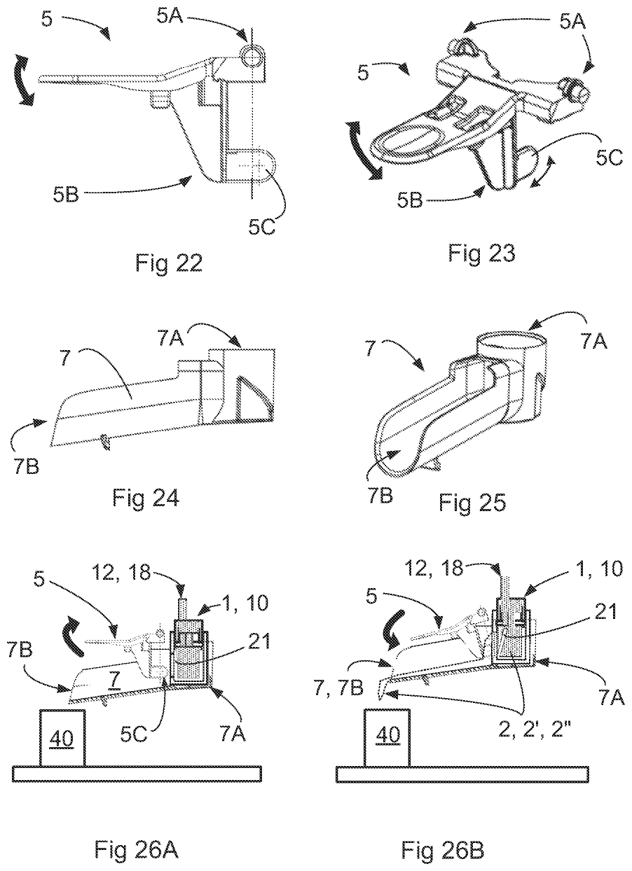

In FIGS. 22 to 26D, another aspect of the leverage or actuating/regulating device/unit or actuator/regulator 50 comprising the lever 5 and the chute/guide 7 is shown. In FIG. 26B, the flow of water is visualised by dotted lines along the chute 7 forming a waterfall-like shape out of the chute 7 to the left. In FIGS. 17A to 17C, the flow of water is visualised in similar way but with a shape filled with a dotted pattern. The chute 7 in FIGS. 24 and 25 for receiving and discharging liquid substance/beverage/water 2, 2′, 2″ when dispensing comprises a first part 7A with a space for receiving the valve 1 and a second/front part or end 7B for discharge of liquid substance/beverage/water. The lever 5 in FIGS. 22, 23, 26A, 26B and 26C has a shape similar to a chair or lowercase h when viewed from the side as in FIG. 22 The back support of the chair 5 forms a horisontal free end to be pushed by a user and is movable. One leg of the chair is a portion 5A of the lever 5 that in principle forms an elongation of the back support horizontally and is pivotally/rotatably attached to the dispensing mounting 30 forming a hinge. The lever 5 also comprises a lower part 5B being the other leg of the chair. The lower part 5B is arranged at a distance from the first upper part 5A. The lower part 5B comprises a front section or free end 5C configured for engagement with the flexible member 20, in particular its side wall 21. The lever 5 is hinged at its upper part 5A in the dispenser mounting 30 enabling the lever 5 to tilt when pushed to move its lower part 5B towards the valve 1 (see embodiments of FIGS. 17A to 17C, 26B. 26C and dotted lines in FIG. 26D for parts 5C, 5B) or away from the valve (see FIGS. 17D, 26A and dotted and solid lines in 26D for parts 5B, 5C). The lower lever part 5B with front/free end 5C work similar to the shaft 6 of embodiments of FIGS. 17A to 17D. The front or free end 5C comprises a thin front part that engages the side wall 21 of the flexible member 20. The thin front part end 5C that engages the flexible member 20 is configured such that it engages the wall 21 of the flexible member 20 (see FIG. 26C) in a rotary/pivot movement that creates a sliding motion along an area of the wall 21 (this contact area is visualised by the straight two-way arrow and the clause-like line to the right inside the flexible member 20) while pushing it towards the centre of the valve 1. The pushing is performed towards the centre axis CA infinitely variable from a start position (see embodiments of FIGS. 8A and 8D, and parts 5B, 5C in solid lines in FIG. 26D) with no flow of dispensed liquid just engaging the wall 21 past intermediary positions (see FIG. 8B and parts 5B, 5C moved along the dotted lines in FIG. 26D) with increasing flow of dispensed liquid until the wall 21 reaches an end position opening up the valve 1 fully for maximum flow of liquid (see FIGS. 8C, 8E and 26D). In some aspects, the lever 5 is biased in a closing direction, i.e. in the upwards direction of the leftmost arrow in FIGS. 17D and 26A to facilitate and more reliably ensure closing or ending of dispensing in case the dispensing is ended before the container 3 is emptied fully to not waste water, i.e. this is the most common scenario of use of the dispenser by e.g. filling only one or two receptacles or cups or glasses 40 before closing the valve 1. The front/free end 5C of the lower lever part 5B is designed as a thin plate with a rounded end configured to engage the flexible member 20 without getting jammed or squeezed in a fold created by the side wall 21 of embodiments in FIGS. 6, 8B, 8C, 8E, 10, 26D when it is pushed inwards by the lever 5 to open up the valve 1 and its discharge opening 15 and at the same time folded inwards while the front/free end 5C pivot and slides/glides along the side wall (see embodiments in FIGS. 17A-17C, 26B, 26C) along the two-way arrow to the right inside the flexible member of FIG. 26C. This smooth movement of the front/free end 5C against the side wall 21 is accomplished by giving the front/free end 5C a thickness as seen in the radial direction or perpendicular direction of the plane of rotary movement of the lever 5 that is smaller or less than the inner width of the fold of the side wall and a height in a direction in parallel with or in the plane of rotary movement of the lever 5 and a first rounded or curved shape in the plane of rotary movement of the lever and a second rounded or curved shape in a plane being perpendicular to the plane of rotary movement of the lever 5, see the shape of front/free end 5C in embodiments of FIGS. 22, 23, 26A to 26D.

The biasing of the lever 5 for more distinct and secure and quicker closing/ending of dispensing could be accomplished by one or more springs at its pivot 5A and/or by means of a separate arm or linkage (not shown). The lever biasing means are adapted to push/urge the lever by engagement therewith into its closed position shown in embodiments of FIGS. 1 to 3, 5A, 5B, 8A, 8D, 9, 16, 17D, 26A and shown in solid lines in FIG. 26D and in the direction of the left arrow in FIGS. 17D, 26A, along the curved two-way arrows of FIG. 26C, i.e. the left one pointing upwards and lowest one pointing to the left and the upmost one pointing to the right and along the straight two-way arrow pointing downwards in FIG. 26D.

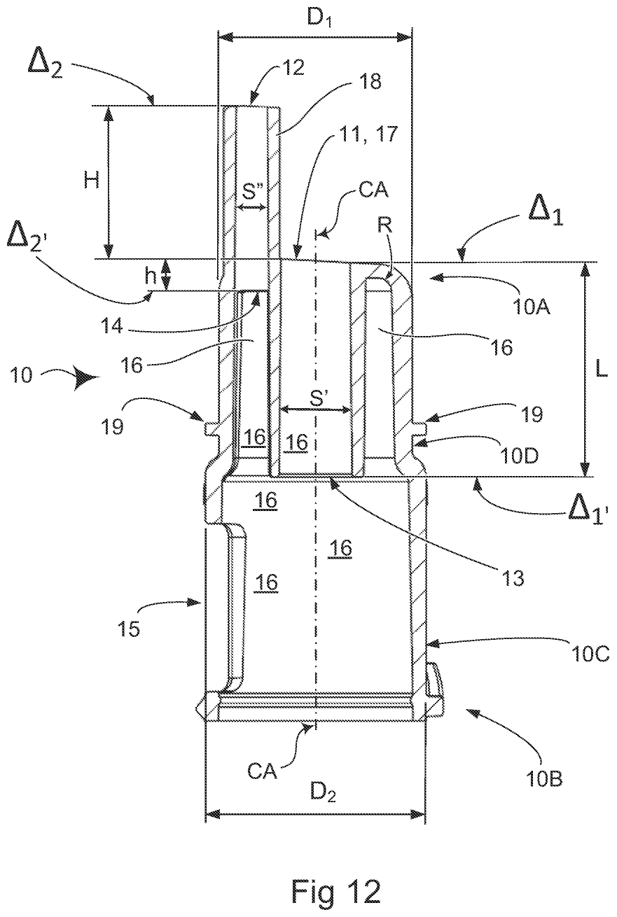

In versions of FIGS. 5A, 5B, 7A, 7B and 12, the first inlet 11 forms a first opening or orifice of the first channel 17 with a through hole extending into the valve housing 10 to enable/let at least one part flow 2′ of water 2 flow into the valve housing. The second water inlet 12 of the valve 1 forms a first opening or orifice of the second channel 18 with a through hole extending into the valve housing 10 to enable/let at least one part flow 2″ of water flow 2 into the valve housing. In some embodiments, the through hole of the first channel 17 has an inner size or width or diameter S′ measured in the radial or crosswise direction of the dispensing direction or water flow WF or in a direction in parallel with the plane of the first valve housing end 10A and/or second end 10B being larger than a corresponding inner size or width or diameter S″ of the through hole of the second channel 18. This relationship between the sizes S′ and S″ of the through hole of the first and second inner channels 17 and 18 is beneficial for letting water 2 out of the valve 1 while letting air AF into the container 3. In some embodiments, the first channel 17 has a first length L ending with its inner outlet 13 opposite its inlet 11 as seen in FIGS. 7A, 7B and 12.

In some embodiments, the above is achieved by the following features of the valve 1 and/or further improved by the following features of the valve as shown in FIGS. 7A, 7B and 12. In the valve 1 according to any of the above and/or below aspects/embodiments, the second water inlet 12 is configured as a first free orifice of the external hollow channel 18 protruding axially from the first valve-housing end 10A. In some embodiments, this external hollow protrusion 18 is extending outwards away from the first valve-housing end 10A similar to a chimney ending in the second water inlet 12 at a distance H from the first valve-housing end. This outer distance H is measured along/in parallel with the centre axis CA/longitudinal axis of the valve housing 10. The external hollow protrusion 18 is provided with a second orifice 14 at the other end opposite its free end with its outer inlet 12. By providing external hollow protrusion 18 with the first outer orifice or water inlet 12 at this distance H or length extending in a direction being substantially perpendicular or perpendicular to this first valve housing end 10A adapted to be in fluid communication with the water content of the container, this enables water 2″ to flow from the second water inlet 12 through the external hollow protrusion 18 (firstly through its free orifice/inlet 12 and further through the inner channel 18 and out of the second orifice 14 into the valve housing 10 and its inner passageway 16 and past the flexible member 20 and out of the at least one outlet 15 via the inner passageway 16 and the flexible member 20 when the flexible member is in its second shape, this being shown in FIGS. 7A and 7B.

In some embodiments, the above is achieved by the following features of the valve 1 and/or further improved by the following features of the valve as shown in FIGS. 7A, 7B and 12. In the valve 1 according to any of the above aspects/embodiments, the inner channel 18 ends in the second orifice 14 opposite the second water inlet 12 inside the valve housing 10 at an inner distance h (this distance being similar to a second or part length of the outer hollow channel 18). The inner distance h is measured inwards from the first valve housing end 10A towards the valve housing outlet 15 in the longitudinal direction of the valve housing 10 in parallel with its centre axis CA. In some embodiments, this advantageous solution enables the valve 1 to let one water flow 2′ entering its first water inlet 11 to flow into valve housing 10 at the other or first distance L as measured from the first valve-housing end 10A inwards in the longitudinal and/or axial direction CA of valve housing 10 and to let another water flow 2″ entering second water inlet 12 of the valve to flow into the valve housing via the second orifice 14 at the second inner distance h as measured from the first valve-housing end 10A in the longitudinal/axial direction CA. In some embodiments, it is an advantage in that the first inner distance or length L is larger than the second inner distance or length h, as shown in FIGS. 7A, 7B and 12.

In some embodiments, the valve 1 shown in FIGS. 7A, 7B, 12 and 19A is configured to enable optimising the water flow 2, 2′, 2″ by increasing or decreasing its first inner size or width or diameter S′ of the through hole of its inner channel 17. In some embodiments, this optimisation is possible to further improve by increasing or decreasing the corresponding second inner size or width or diameter S″ of the through hole of second channel 18 as long as this second inner size or width or diameter S″ of the through hole of second channel 18 is less or smaller than the first inner size or width or diameter S′ of the through hole of inner channel 17. In some embodiments, this optimisation of the two inner separate sizes S′ and S″ of the through holes of first and second inner channels 17 and 18 separately or in relation to each other enable further improvement of the effect of air flow and control of the air flow AF, i.e. letting in of air AF into container 3 is easier, quicker, smoother, i.e. with no or much less or much smaller air bubbles incurring no or almost no vibrations, making dispensing much quieter, even silent or noiseless or at least with a very quiet operation, and more reliably achieved when exchanging water 2 in the container with air during dispense and/or discharge.

In some embodiments, an important optimisation and design of the valve 1 concern that the total inner volume of the first inlet 11 and inner channel 17 (i.e. their volume containing water) should be larger or greater than the total inner volume of the second inlet 12 and outer channel 18 (i.e. their volume containing water), and that inner channel 17 and its inner outlet 13 is placed closer to the outlet 15 and/or below the inner outlet 14 of outer or upper channel 18, i.e. the inner outlet 13 and inner outlet 14 should not be in level or flush with each other or end at the same height in the vertical direction relative the valve housing 10 as shown in FIGS. 7A, 7B and 12, in other words, the inner outlet 14 should end above the other inner outlet 13 as seen in the vertical direction. In some embodiments, the same goes for the lower or first outer/external water inlet 11 at its level Δ₁ relative the upper or second outer/external water inlet 12 at its level Δ₂, this being visualised on FIG. 1. Hence, the levels Δ₁ and Δ₂ on FIG. 1 show that the level or pillar of water above the first inlet 11 is larger or higher or longer than the level or pillar of water above the second inlet 12, wherefore the incurred water pressure on the second inlet 12 is less than on the first inlet 11. The same reasoning is applicable regarding levels Δ_{1′} and Δ_{2′} shown in FIGS. 7A, 7B and 12 as those levels are also at differing heights or distances incurring different pressures at each level, i.e. the pressure at the lower level Δ_{1′} is higher than at the higher level Δ_{2′}.

This design of the valve 1 enables starting to let in any airflow AF as late as possible in the dispensing process to minimise the amount of air let into the container 3 and also the time of airing and adding of oxygen/oxygenation into the water 2, 2′, 2″.

Any airflow AF follows the path or line of “least resistance” meaning that the second external or outer inlet 12 is the most favourable “way” for incoming air AF as it is placed “higher up” at its level Δ₂ with a shorter pillar or “roof” of water 2 to “penetrate” compared to the pillar or “roof” of water 2 above the level Δ₁ of the first external/outer inlet 11.

This layout of the valve 1 means that airflow AF is starting being “sucked in” when the pressure or negative pressure inside container 3 has reached a sufficient or certain level or value below the outer pressure or the pressure outside the container, such as the outer surrounding atmospheric pressure.

In embodiments of FIGS. 5A, 5B, 7A, 7B, 11A and 11B, orifice or first water inlet 11 is shown with a somewhat narrower mouth or opening compared to its inner size or width or diameter S′ at or in its inner channel 17, but could have the size or width or diameter as this inner measure S′ as shown in the embodiment of FIG. 12.

In FIG. 12, a sectional plan view of the upper part, i.e. the valve housing 10 of FIGS. 9 and 10 is shown in an aspect without the lower part, i.e. the flexible member 20, in these figs. with a varying shape along its length/longitudinal axis CA. Valve housing 10 has a varying outer or external shape or size or width or thickness or diameter along its length visualised by numerals D₁ and D₂. These parameters or letters D₁ and D₂ do not necessarily mean diameters as this outer/external shape or size or width or thickness or diameter depends on the geometry of the valve housing 10, i.e. if the valve housing is cylindrical, the measure or parameter D₁ or D₂ is a diameter, while if the valve housing 10 is at least partly shaped with straight or plane sides, this measure/parameter D₁/D₂ could be a width or thickness, e.g. a square cross-section would mean that the measure/parameter is a thickness or width. A first/top portion of valve housing 10 along its length and centre axis CA as measured from its first/top end 10A and towards and up to or including a middle portion at or adjacent its external flange or edge 19 has a first valve housing size or width or thickness or diameter D₁. A second/bottom/end portion of valve housing 10 along its length and centre axis CA as measured from its second or bottom end 10B and towards and up to or including a middle portion at or adjacent its external flange or edge 19 has a second valve housing size or width or thickness or diameter D₂. These shapes or sizes or widths or thicknesses or diameters D₁, D₂ are equal or substantially the same as shown in embodiments of FIGS. 1 to 11B or different as shown in FIG. 12. In one aspect, the first valve housing size or width or thickness or diameter D₁ is smaller or larger than the second size or width or thickness or diameter D₂. In another aspect, the first valve housing size or width or thickness or diameter D₁ is smaller than the second size or width or thickness or diameter D₂. In yet another aspect, the first valve housing size or width or thickness or diameter D₁ is larger than the second size or width or thickness or diameter D₂. The size or protruding distance radially of the external flange 19 is adaptable relative containers 3 with larger or smaller discharge openings, i.e. a larger discharge opening of a container 3 would in some aspects require an increase of this size or protruding distance radially of the flange 19, while, in other aspects, the size or protruding distance radially of the flange 19 could be kept as shown. In other aspects, the size or protruding distance radially of the flange 19 could be decreased as long as a secure and leak-proof engagement between valve 1 and container 3 by use of the connector 4, 4′, 4″ is achieved, this criteria goes for all sizes or protruding distances radially for the flange 19. The first valve housing shape or size or width or thickness or diameter D₁ of the valve 1 corresponds (depending on tolerances and measures of interconnected parts of course) to the inner shape or size or width or thickness or diameter of the discharge opening of associated container 3. To improve leak-proof engagement between valve 1 and container 3 a sealing 60 is placeable between connector 4, 4′ and flange 19 (see embodiment of FIG. 18) on the upper side of the flange so that the sealing 60 is arranged between container and flange while the connector engages the lower side of flange 19 with an inner edge 4F. Connector halves 4A and 4B each comprises an inner edge 4F that complements each other when the connector 4 is finally attached around the circumference of valve housing 10. Numerals related to water level are the following: WL is a general water level in a container 3 and WLH is a water level in a filled/full container 3, such as a high level (the container could be 100% full but only within technical limits); WLI is a water level in the container when being emptied (this level is less than WLH but could be equal just at the start of dispensing of the container and is defined as an intermediary level between full container and one with a low level or fully emptied with no/zero level; WLL is a water level in the container being emptied (this level is a low one and/or less than WLH and WLI but could be equal to WLI as the levels change smoothly with no distinct step or jump between levels, i.e. the low level WLL corresponds to a level in a container with a water level lower/less than WLI but of course higher than an emptied container with no/“zero” water level WL.

The valve 1 according to any aspect/embodiment above and/or below is designed so that, when open/-ed, a steady/continuous and non-interrupted flow of content out of container 3 during dispensing is guaranteed. Flow of liquid content 2, 2′, 2″ out of container 3 is preferably the largest/highest when the container is full, whereby an high amount/flow/a lot of beverage or liquid or water is let out and gradually decreasing while beverage/liquid/water is dispensed and the container is emptied, without collapsing or while collapsing, wherein—at a certain point—the valve 1 starts letting in air AF into the container and the flow rate increases (again).

As the valve 1 is fully detachable into all its separate entities making it up, an easy disassembly facilitating cleaning all the surfaces of the valve is achieved. In particular, flexible member 20 has a cup shape with surfaces, in particular its inner surfaces, contacting liquid substance/water shaped with rounded inner contours or sufficiently large inner radius/radii as shown in the lower part of the valve 1 at the inside at ends 10B, 10C of FIGS. 5A, 5B, 7A, 7B, 11A and 11B. The same/similar design, shape and size of other surfaces of the valve 1, in particular its inner surfaces at its upper part 10A of FIGS. 5A, 5B, 7A, 7B, 11A, 11B and 12, is done to eliminate or at least reduce the number and locations of too sharp corners, folds or the like where dirt and/or contaminations can attach/build-up and form undesired locations of germs/bacteria forming biofilms thereon. This also enhances cleaning of those surfaces by being able to easily detach the valve 1 and its flexible member 20 and other valve components for thorough disinfection/cleaning. In one aspect, the inner surface/corners of the bottom of the flexible member 20 at the valve end 10C as seen in embodiments of FIGS. 5A, 5B, 7A, 7B, 11A and 11B has/have a radius R of at least 3 mm. The upper parts at end 10A of the valve 1 also have sufficiently large inner radii R for the same reasons.

An advantage of an aspect/embodiment of the disclosure is to provide a dispensing valve 1 and function, useful in a dispensing device, having an improved distinctiveness when being opened and closed.

An advantage of an aspect of the disclosure is to provide a dispensing valve 1 and function, useful in a dispensing device, having a more reliable and/or reproducible and simpler emptying of a closed and airtight/airproof container 3 by means of an improved changing of air AF with liquid substance 2, 2′, 2″ in the container when it is being emptied/dispensed.

An advantage of the disclosure is to provide a dispensing valve 1, useful in a dispensing device, having a more distinct/secure/reproducible/reliable and improved sealing when closed by means of the container content in itself in that the content, i.e. the liquid substance 2, 2′, 2″ increases the sealing abutment and mating of sealing entities, i.e. surfaces and parts adapted for enabling the sealing, by pressing/urging these sealing entities towards each other in a direction from within the valve housing 10 and outwards.

An advantage of the dispensing valve 1 is that it is useful in a dispensing device and has a more reliable/reproducible and simpler emptying of the closed and airtight/airproof container 3 by means of an improved changing of air AF with liquid substance 2, 2′, 2″ in the container when the container is being emptied/dispensed.

In an aspect of the disclosure, there is provided a valve 1 for dispensing liquid substance, such as beverages or water 2, 2′, 2″ in liquid form from a closed and airtight container 3, the valve 1 comprising a valve housing 10 with a first end 10A configured to be detachably attached to and in fluid communication with the container and a second end 10B at which the liquid substance is to be dispensed in a dispensing direction WF by means of gravity, and two inlets for the liquid substance, a first liquid substance inlet 11 and a second liquid substance inlet 12 arranged at the first valve housing end 10A and at least one outlet 15 configured to let out the liquid substance is arranged at/closer to the second valve housing end 10B, which in- and outlets 11, 12, 15 are configured to be in fluid communication via at least one inner passageway 16 through the valve housing 10, and a at least partly flexible member 20 detachably fitted into the valve housing, the flexible member being malleable infinitely variable between a first shape sealingly closing off the inner passageway to hinder dispense of the liquid substance from the container and a second shape opening up the inner passageway to enable dispensing the liquid substance from at least one inlet via the inner passageway and out of the valve housing 10 via the at least one outlet 15, the valve 1 being characterized in that at least one of the first and/or second external/outer liquid substance inlets 11, 12 is/are configured to let in airflow AF into the container 3, and that the first outer/external liquid substance inlet 11 for receiving liquid substance 2′ is arranged closer to the at least one outlet 15 than the second outer/external liquid substance inlet 12 for receiving liquid substance 2″, in the dispensing direction WF, F.

### NOMENCLATURE

1: Valve. 2, 2′, 2″: Liquid substance/Beverage/Water in liquid form. 3: Container, e.g. bottle. 3A: Discharge end of container. 3B: Closed end/bottom of container. 4, 4′: Connector, such as a nut and/or fitting with one or more sealings 4″, preferably two sealings in the form of an o-/packing ring. 4A: First connector half. 4B: Second connector half. 4C: Inner connector thread.

4D: Connector halves fitting/attachment. 4E: Connector grip. 5: Lever. 5A: Pivot/Hinge of lever. 5B: Lower part of lever. 5C: Valve engaging part of lever. 6: Shaft. 7: Chute or guide for receiving and discharging liquid substance/beverage/water when dispensing. 7A: First part of chute for receiving liquid substance/beverage/water. 7B: Second/Front part of chute for discharge of liquid substance/beverage/water. 8: Electronic unit. 9: Display/Screen for information and/or control, e.g. a touch screen. 10: Valve housing. 10A: First/Top end of valve housing. 10B: Second/Bottom/Discharge/Dispense end of valve housing. 11: First external liquid substance inlet. 12: Second external liquid substance inlet. 13: First internal liquid substance outlet. 14: Second internal liquid substance outlet. 15: First external liquid substance outlet. 16: Inner passageway through valve housing. 17: First hollow inner valve housing protrusion or channel. 18: Second inner hollow valve housing channel. 19: Outer/External valve housing flange or edge. 20: Flexible member. 21: Side wall/part of flexible member. 22: Solid bottom of flexible member. 23: Inner space of flexible member. 24: Slit of flexible member. 30: Dispensing mounting or holder or support. 31: Container and kit receiving portion of the dispensing mounting. 32: Recess for receiving discharge end 3A/valve. 40: Cup/Glass/Receptacle. 50: Actuating/Regulating device/unit or actuator/regulator comprising lever 5, shaft 6 and chute/guide 7. 60: Sealing between connector and flange 19. 100: Replaceable/Exchangeable subsystem/assembly/module/kit comprising container 3+valve 1+connector 4. 200: Dispensing system comprising replace-/exchangeable subsystem 100; regulator 50; electronic unit 8; display 9; dispensing mounting 30 w receiving portion 31+recess 32.

1. A valve for dispensing liquid substance, such as beverages or water in liquid form from a closed and airtight container, the valve comprising a valve housing with a first end configured to be detachably attached to and in fluid communication with the container and a second end at which the liquid substance is to be dispensed in a dispensing direction by means of gravity, wherein at least one inlet configured to receive the liquid substance is arranged at the first valve housing end and at least one outlet configured to let out the liquid substance is arranged at/closer to the second valve housing end, which in- and outlets are configured to be in fluid communication via at least one inner passageway through the valve housing, and a at least partly flexible member detachably fitted into the valve housing, the flexible member being malleable infinitely variable between a first shape sealingly closing off the inner passageway to hinder dispense of the liquid substance from the container and a second shape opening up the inner passageway to enable dispensing the liquid substance from at least one inlet via the inner passageway and out of at least one outlet,
wherein the valve comprises two inlets for the liquid substance, a first liquid substance inlet and a second liquid substance inlet at its first valve housing end, and that
the first liquid substance inlet for receiving liquid substance is arranged closer to the at least one outlet than the second liquid substance inlet for receiving liquid substance, in the dispensing direction.

2. The valve according to claim 1, wherein the at least partly flexible member is malleable between its first shape sealingly closing off both the inner passageway and the at least one valve housing outlet for hindering dispense of liquid substance from the container and its second shape opening up both the inner passageway and the at least one valve housing outlet to enable dispensing liquid substance from at least one liquid substance inlet via the inner passageway and out of the at least one valve housing outlet.

3. The valve according to claim 1, wherein the first liquid substance inlet is configured as a first orifice of an inner hollow channel or protrusion extending a length inside the valve housing from the first valve housing end towards the second valve housing end and ending in a second outlet or orifice at/adjacent/close to the flexible member to enable liquid substance to flow from the first liquid substance inlet through the inner hollow protrusion and out of the second outlet or orifice and the at least one outlet via the inner passageway and the flexible member when the flexible member is in its second shape.

4. The valve according to claim 1, wherein the valve housing has a centre axis extending in parallel with the length of the valve housing and the first liquid substance inlet is aligned with the valve housing centre axis and the second liquid substance inlet is radially offset/displaced relative the valve housing centre axis.

5. The valve according to claim 1, wherein the second liquid substance inlet is configured as a first orifice of an external hollow channel or protrusion on the first valve housing end, which external hollow protrusion is extending outwards away from the first valve housing end similar to a chimney ending in the second liquid substance inlet as a free orifice at a distance from the first valve housing end to enable liquid substance to flow from the second liquid substance inlet through the external hollow protrusion and out of its second outlet or orifice into the valve housing and out of at least one outlet via the inner passageway and the flexible member when the flexible member is in its second shape.

6. The valve according to claim 5, wherein only the second liquid substance inlet is configured to enable air to flow into the at least one outlet and into the valve housing and further into the second outlet or orifice of the external hollow channel or protrusion via the inner passageway and the flexible member in a direction substantially opposite or opposite the liquid substance dispensing direction and dispensing direction and out through the external hollow channel or protrusion and second liquid substance inlet acting as a free orifice while liquid substance flows in when the flexible member is in its second shape.

7. The valve according to claim 1, wherein the first liquid substance inlet is arranged flush with the first valve housing end or below the upper/exposed surface of the first valve housing end as an opening in the first valve housing end.

8. The valve according to claim 1, wherein the second liquid substance inlet is arranged at a free end of an external hollow channel or protrusion extending away and outwards from the first valve housing end in a direction substantially perpendicular or perpendicular to the extension plane of the first valve housing end, which tubular protrusion ends at a distance from the first valve housing end.

9. The valve according to claim 1, wherein the at least one valve housing outlet is an opening through the valve housing, which opening extends substantially perpendicularly or perpendicularly to the length of the valve housing.

10. The valve according to claim 1, wherein the valve housing comprises at least one side wall extending substantially perpendicularly or perpendicularly to its first and second ends, which at least one side wall is fenestrated via at least one through opening forming the at least one outlet, which outlet has an extension plane being substantially in parallel with or in parallel with the at least one side wall/centre axis of the valve housing.

11. The valve according to claim 1, wherein the flexible member is formed with at least a partly tubular shape and comprises at least one wall section being part of the at least partly tubular shape, which at least one wall section is adapted to sealingly abut against the at least one valve housing outlet from inside the valve housing when the flexible member is in its first state.

12. The valve according to claim 1, wherein the flexible member has a U-shaped cross-section formed by at least one side wall forming the legs of the U-shape and a solid bottom forming the base of the U-shape and is configured to be introduced into the second valve housing end until the solid bottom abuts the second valve housing end and to be detachably and attached to this second end to sealingly close off this second valve housing end as a lid/plug.

13. The valve according to claim 1, wherein the flexible member comprises a malleable wall section or side wall configured to sealingly abut against the at least one valve housing outlet from inside the valve housing when the flexible member is in its first shape by being at least partly rounded to sealingly fit/abut against the inside of at least one side wall of the valve housing being at least partly rounded in a corresponding manner as the malleable section of the flexible member to achieve matching rounded sealing surfaces.

14. The valve according to claim 5, wherein the second outlet or orifice of the external hollow protrusion is configured to end inside the valve housing at an inner distance measured inwards from the first valve housing end.

15. The valve according to claim 14, wherein the valve is adapted to let liquid substance enter the first liquid substance inlet of the valve to flow into the valve housing at a first distance measured from the first valve housing end in the longitudinal/axial direction the valve housing and adapted to let the liquid substance enter the second liquid substance inlet of the valve to flow into the valve housing via the second outlet or orifice at the second inner distance measured from the first valve housing end in the longitudinal/axial direction, wherein the first inner distance is larger than the second inner distance.

16. The valve according to claim 1, wherein the first liquid substance inlet of the valve is configured to form a first orifice of a first inner hollow channel or protrusion with a through hole extending into the valve housing to enable liquid substance to flow into the valve housing and the second liquid substance inlet of the valve is configured to form a first orifice of an external hollow channel or protrusion with a through hole extending into the valve housing to enable liquid substance to flow into the valve housing, wherein the through hole of the first inner hollow channel or protrusion has an inner size measured in the radial or cross-wise direction of the valve housing/dispensing direction or measured in a direction in parallel with the plane of the first valve housing end being larger than the corresponding inner size of the through hole of the external hollow/second channel or protrusion.

17. The valve according to claim 14, wherein the second outlet or orifice of the external hollow protrusion is arranged closer to the at least one outlet than the first orifice or liquid substance inlet in the dispensing direction.

18. The valve according to claim 1, wherein the valve housing has a varying outer/external shape or size or width or thickness or diameter along its length, wherein a first/top portion of the valve housing along its length as measured from its first/top end and towards and to a middle portion at or adjacent its external flange or edge has a first valve housing size or width or thickness or diameter and a second/bottom/end portion of the valve housing along its length as measured from its second/bottom end and towards and to a middle portion at or adjacent its external flange or edge has a second valve housing size or width or thickness or diameter, which shapes or sizes or widths or thicknesses or diameters are equal or different.

19. The valve according to claim 18, wherein the first valve housing size or width or thickness or diameter is smaller or larger than the second size or width or thickness or diameter.

20. The valve according to claim 18, wherein the first valve housing size or width or thickness or diameter is smaller than the second size or width or thickness or diameter.

21. The valve according to claim 18, wherein the first valve housing size or width or thickness or diameter is larger than the second size or width or thickness or diameter.

22. The valve according to claim 1, wherein the flexible member has its surfaces, in particular its inner surfaces, contacting liquid substance/water shaped with rounded contours or radius/radii of at least 3 mm.

23. The valve according to claim 22, wherein the flexible member comprises inner surfaces/corners of its bottom with a radius of at least 3 mm.
